(19) United States
(12) Patent Application Publication
(10) Pub. No.: US 2024/0097114 A1
(43) Pub. Date: Mar. 21, 2024

(54) INTERLAYERS FOR CATHODE/SOLID ELECTROLYTE INTERFACES IN SOLID-STATE BATTERIES AND METHODS OF MAKING THE SAME

(71) Applicants: CORNING INCORPORATED, Corning, NY (US); SHANGHAI INSTITUTE OF CERAMICS, CHINESE ACADEMY OF SCIENCES, Shanghai (CN)

(72) Inventors: Michael Edward Badding, Campbell, NY (US); Mingli Cai, Nantong (CN); Jun Jin, Shanghai (CN); Zhen Song, Painted Post, NY (US); Zhaoyin Wen, Shanghai (CN); Tongping Xiu, Shanghai (CN); Liu Yao, Shanghai (CN)

(21) Appl. No.: 18/368,291

(22) Filed: Sep. 14, 2023

(30) Foreign Application Priority Data
Sep. 19, 2022 (CN) 202211137671.3

(51) Int. Cl. H01M 4/36; H01M 4/131; H01M 4/38; H01M 4/505; H01M 4/525; H01M 4/66; H01M 10/0562; H01M 10/0568; H01M 10/0569; H01M 10/0585; H01M 10/42

(52) U.S. Cl. CPC H01M 4/366; H01M 4/131; H01M 4/382; H01M 4/505; H01M 4/525; H01M 4/661; H01M 10/0562; H01M 10/0568; H01M 10/0569; H01M 10/0585; H01M 10/4235; H01M 2004/028

(57) ABSTRACT

Batteries include a current collector, a cathode, an interlayer disposed on the cathode, a solid-state electrolyte disposed on the interlayer, and a lithium anode disposed on the solid-state electrolyte. In aspects, the interlayer includes a lithium salt and a sulfone compound within a polymeric matrix. In aspects, the interlayer includes a lithium salt and a sulfone compound. In aspects, methods of forming a battery comprise disposing a precursor solution comprising a lithium salt, a sulfone compound, and a monomer on a first major surface of a cathode. Methods can further include curing the precursor solution to form an interlayer including the lithium salt and the sulfone compound within a polymeric matrix. In aspects, methods can include disposing a lithium salt and a sulfone compound on a first major surface of a cathode. Methods further include disposing a solid-state electrolyte over the first major surface of the cathode.

### CROSS-REFERENCE TO RELATED APPLICATIONS

This application claims the benefit of priority under 35 U.S.C. § 119 of Chinese Patent Application Serial No. 202211137671.3 filed on Sep. 19, 2022 the content of which is relied upon and incorporated herein by reference in its entirety.

### FIELD

The present disclosure relates to interlayers for cathode/solid-state electrolytes and methods of making the same, and more particularly interlayers comprising a lithium salt and a sulfone compound comprising a lithium salt in solid-state batteries and methods of making the same.

### BACKGROUND

Solid-state batteries (SSBs) (e.g., SS lithium (Li) metal batteries based on inorganic solid-state electrolytes (SSEs) (such as garnet-type SSE)) have attracted much attention due to their high safety, improved energy density, high ionic conductivity, and stability against Li metal.

However, conventional Li-metal batteries often suffer from high interfacial resistance between the cathode and solid-state electrolyte. Due to the rigid nature of the ceramic SSE, contact between active particles and the SSE is a “point-surface” contact, which leads to a limited contact area at the cathode-SSE interface and poor Li-ion (Li⁺) accessibility inside the cathode.

To address these problematic issues, proposed solutions include employing a low melting compound (e.g., Li₃BO₃ (LBO), Li_{2.3-x}C_{0.7+x}B_{0.3-x}O₃ (LCBO), etc.) as a bonding material and Li-ion conductor to lower the cathode/SSE interfacial resistance. However, the above-proposed configurations exhibit low Li-ion conductivity, large impedance, and low current density at battery operating conditions. Consequently, there is a need to address these issues.

### SUMMARY

The present disclosure provides batteries and methods of making the same comprising an interlayer comprising a lithium salt and a sulfone compound positioned between (e.g., at an interface) a cathode and a solid-state electrolyte. Providing the interlayer can decrease an interfacial resistance between the cathode and a solid-state electrolyte. In aspects, the interlayer can be a liquid electrolyte that can provide continuous and uniform ion paths at the interface and inside the cathode (e.g., wetting the cathode/SSE interface), for example, due to the high ionic conductivity of the liquid electrolyte and the ability of the liquid electrolyte to conform to the first major surface of the cathode and/or a surface of the solid-state electrolyte. For example, as demonstrated in the Examples discussed below, liquid electrolyte interlayers in accordance with the present disclosure can enable reduced interfacial resistance (e.g., about 100 Ωcm² or less or about 50 Ωcm² or less at 25° C. as-formed, after 250 cycles, and/or after 350 cycles) and/or increased capacity retention (e.g., about 70% or more at 25° C. after 250 cycles or 350 cycles). Compared to ionic liquid electrolytes, interlayers according to the present disclosure provide a lower-cost alternative that can be better suited for large-scale applications.

In aspects, the interlayer can comprise a crosslinked polymer matrix that can increase a viscosity of the interlayer and/or decrease a mobility of the lithium salt therein, which can reduce a rate of degradation of the cathode current collector. Providing a polymer matrix in the interlayer can reduce an amount of the lithium salt and/or sulfone compound that can travel away from the interface between the cathode and the solid-state electrolyte, which can increase a capacity retention of the solid-state battery and/or decrease an interfacial resistance after cycling. As demonstrated in the Examples, providing a polymer matrix (e.g., crosslinked polymer matrix) interlayer can reduce corrosion of the first current collector by the lithium salt in the interlayer, which can enable increased operating temperatures, increased longevity, and/or increased capacity retention of the solid-state battery. Providing the polymer matrix in accordance with the present disclosure can balance reducing the mobility of the lithium salt to reduce corrosion of the solid-state battery (e.g., current collector) with a potential decrease in ionic conductivity of the interlayer. As demonstrated in the Examples below, the polymeric matrix in the interlayer can reduce corrosion of the current collector while maintaining good capacity and capacity retention.

Providing and/or maintaining a low (e.g., about 300 Ωcm² or less, about 100 Ωcm² or less) interfacial resistance of the interlayer and/or the solid-state battery can enable the solid-state battery to have a longer life (e.g., withstand more cycles without failure), reduce losses and heating from increased interfacial resistance, and/or reduce the formation of dendrites (e.g., lithium dendrites) that can lead to failure of the solid-state battery. The interfacial resistance of interlayers and solid-state batteries containing the same in accordance with aspects of the disclosure can be reduced by more than one order of magnitude (e.g., 100× or more, 1000× or more) than a solid-state battery without an interlayer, which can have an interfacial resistance on the order of 100,000 Ωcm². Providing and/or maintaining a high capacity (e.g., 150 mAh/g or more as-formed or after 250 cycles or after 350 cycles at 25° C., 140 mAh/g or more as-formed or after 90 cycles at 45° C.,) can enable the solid-state battery to make efficient use of cathode materials (e.g., for an intended use for a longer period of time) than would otherwise be possible. Maintaining a high capacity retention (e.g., (e.g., 70% or more after 250 cycles at 25° C., 90% or more after 350 cycles at 25° C., 90% or more after 90 cycles at 45° C.) can enable the solid-state battery to be functional for an intended use for a longer period of time than would otherwise be possible.

Providing the ratio of the volume of the electrolyte interlayer to the area of the first major surface of the cathode can be sufficient to wet the interface between the cathode and the solid-state electrolyte while minimizing concerns associated with traditional liquid electrolytes (e.g., in liquid-based batteries or in hybrid liquid-solid batteries). As demonstrated in the Examples discussed below, providing a molar ratio in accordance with the present disclosure can provide a thermally stable and/or oxidatively stable interlayer that can increase a longevity of the solid-state battery and/or increase a capacity retention of the solid-state battery. Providing a thermally stable interlayer (e.g., to 100° C. or more, about 150° C. or more, about 175° C. or more) can increase a range of operating temperatures for the solid-state battery, increase a capacity retention of the solid-state battery, and/or increase a longevity of the solid-state battery.

Providing a cathode loading from about 1 mg/cm² to about 5 mg/cm² in combination with the interlayer described herein can make efficient use of cathode materials, for example, as demonstrated by the capacity in the Examples below. Providing the ratio of the volume of the interlayer to the area of the first major surface of the cathode can be sufficient to wet the interface between the cathode and the solid-state electrolyte while minimizing concerns associated with traditional liquid electrolytes (e.g., in liquid-based batteries or in hybrid liquid-solid batteries). Although not shown, the cathode can be disposed on the first current collector while the interlayer is disposed on the cathode.

Some example aspects of the disclosure are described below with the understanding that any of the features of the various aspects may be used alone or in combination with one another.

Aspect 1. A battery, comprising:
a current collector;
a cathode comprising a first major surface and a second major surface opposite the first major surface, the current collector disposed on the second major surface;
an interlayer disposed on the first major surface of the cathode, the interlayer comprising a polymeric matrix, a lithium salt, and a sulfone compound, the lithium salt and the sulfone compound positioned within the polymeric matrix;
a solid-state electrolyte disposed on the interlayer; and
a lithium anode disposed on the solid-state electrolyte.

Aspect 2. The battery of aspect 1, wherein the polymeric matrix comprises an acrylic-based polymer.

Aspect 3. The battery of any one of aspects 1-2, wherein an interfacial resistance between the cathode and the solid-state electrolyte, as-formed, is about 300 Ωcm² or less at 25° C.

Aspect 4. The battery of any one of aspects 1-3, wherein the battery comprises a capacity retention of about 90% or more after 90 cycles at 0.2 C with a cutoff voltage of 4.5V and at 45° C.

Aspect 5. The battery of any one of aspects 1-3, wherein the battery comprises a capacity of about 150 mAh/g or more after 90 cycles at 0.2 C with a cutoff voltage of 4.5V and at 45° C.

Aspect 6. The battery of any one of aspects 1-5, wherein the lithium salt comprises at least one of: lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof.

Aspect 7. The battery of any one of aspects 1-6, wherein the sulfone compound comprises at least one of: sulfolane, 3-methylsulfolane, dimethyl sulfone, ethyl methyl sulfone, or combinations thereof.

Aspect 8. The battery of any one of aspects 1-7, wherein the sulfone compound comprises sulfolane, and the lithium salt comprises lithium bis(trifluoromethanesulfonyl)imide (LiTFSI).

Aspect 9. The battery of any one of aspects 1-8, wherein a molar ratio of the lithium salt to the sulfone compound is about 0.125 or more.

Aspect 10. The battery of aspect 9, wherein the molar ratio of the lithium salt to the sulfone compound is from about 0.2 to about 1.

Aspect 11. The battery of any one of aspects 1-10, wherein the current collector comprises aluminum.

Aspect 12. The battery of any one of aspects 1-11, wherein the cathode comprises at least one of lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0<d<1, 0<e<1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

Aspect 13. The battery of any one of aspects 1-12, wherein a ratio of a weight of the cathode to an area of the first major surface is from about 1 mg/cm² to about 5 mg/cm².

Aspect 14. The battery of any one of aspects 1-12, wherein a ratio of a volume of the interlayer to an area of the first major surface of the cathode from about 5 μL/cm² to about 20 μL/cm².

Aspect 15. The battery of any one of aspects 1-14, wherein the solid-state electrolyte comprises lithium, lanthanum, zirconium, and oxygen.

Aspect 16. The battery of aspect 15, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N═In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I═In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or a combination thereof.

Aspect 17. A battery, comprising:
a current collector;
   a cathode comprising a first major surface and a second major surface opposite the first major surface, the current collector disposed on the second major surface;
   an interlayer disposed on the first major surface of the cathode, the interlayer comprising a lithium salt and a sulfone compound;
a solid-state electrolyte disposed on the interlayer; and
a lithium anode disposed on the solid-state electrolyte.

Aspect 18. The battery of aspect 17, wherein an interfacial resistance between the cathode and the solid-state electrolyte, as-formed, is about 100 Ωcm² or less at 25° C.

Aspect 19. The battery of aspect 17, wherein the battery comprises a capacity retention of about 70% or more after 250 cycles at 0.2 C with a cutoff voltage of 4.6V and at 25° C.

Aspect 20. The battery of aspect 17, wherein a capacity retention is about 90% or more after 350 cycles at 0.2 C with a cutoff voltage of 4.5V and at 25° C.

Aspect 21. The battery of aspect 17, wherein the battery comprises a capacity of about 140 mAh/g or more after 90 cycles at 0.2 C with a cutoff voltage of 4.5V and at 25° C.

Aspect 22. The battery of any one of aspects 17-21, wherein the lithium salt comprises at least one of: lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof.

Aspect 23. The battery of any one of aspects 17-22, wherein the sulfone compound comprises at least one of: sulfolane, 3-methylsulfolane, dimethyl sulfone, ethyl methyl sulfone, or combinations thereof.

Aspect 24. The battery of any one of aspects 17-23, wherein the sulfone compound comprises sulfolane, and the lithium salt comprises lithium bis(trifluoromethanesulfonyl)imide (LiTFSI).

Aspect 25. The battery of any one of aspects 17-24, wherein a molar ratio of the lithium salt to the sulfone compound is about 0.125 or more.

Aspect 26. The battery of aspect 25, wherein the molar ratio of the lithium salt to the sulfone compound is from about 0.2 to about 1.

Aspect 27. The battery of any one of aspects 17-26, wherein the current collector comprises aluminum.

Aspect 28. The battery of any one of aspects 17-27, wherein the cathode comprises at least one of lithium cobaltite (LCO), lithium manganite spinel (LMO), lithium nickel cobalt aluminate (NCA), lithium nickel manganese cobalt oxide (NCM) (LiNi_{d}CoₑMn_{-d-e}O₂, where 0<d<1, 0<e<1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

Aspect 29. The battery of any one of aspects 17-28, wherein a ratio of a weight of the cathode to an area of the first major surface is from about 1 mg/cm² to about 5 mg/cm².

Aspect 30. The battery of any one of aspects 17-28, wherein a ratio of a volume of the interlayer to an area of the first major surface of the cathode from about 5 μL/cm² to about 20 μL/cm².

Aspect 31. The battery of any one of aspects 17-30, wherein the solid-state electrolyte comprises lithium, lanthanum, zirconium, and oxygen.

Aspect 32. The battery of aspect 31, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N═In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I═In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or
a combination thereof.

Aspect 33. A method of forming a battery comprising:
disposing a precursor solution comprising a lithium salt, a sulfone compound, and a monomer on a first major surface of a cathode;
curing the monomer to form an interlayer comprising polymeric matrix with the lithium salt and the sulfone compound positioned within the polymeric matrix; and
disposing a solid-state electrolyte over the first major surface of the cathode, the interlayer positioned between the cathode and the solid-state electrolyte.

Aspect 34. The method of aspect 33, wherein the precursor solution comprises from about 2 wt % to about 20 wt % of the monomer.

Aspect 35. The method of any one of aspects 33-34, wherein the monomer is an acrylic monomer and the polymeric matrix comprises an acrylate-based polymer.

Aspect 36. The battery of any one of aspects 33-35, wherein a molar ratio of the lithium salt to the sulfone compound is about 0.125 or more.

Aspect 37. The battery of aspect 36, wherein the molar ratio of the lithium salt to the sulfone compound is from about 0.2 to about 1.

Aspect 38. The method of any one of aspects 33-37, wherein an interfacial resistance between the cathode and the solid-state electrolyte, as-formed, is about 300 Ωcm² or less at 25° C.

Aspect 49. The method of any one of aspects 33-38, wherein the battery comprises a capacity retention of about 90% or more after 90 cycles at 0.2 C with a cutoff voltage of 4.5V and at 45° C.

Aspect 40. The method of any one of aspects 33-38, wherein the battery comprises a capacity of about 150 mAh/g or more after 90 cycles at 0.2 C with a cutoff voltage of 4.5V and at 45° C.

Aspect 41. The method of any one of aspects 33-40, wherein the lithium salt comprises at least one of: lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof.

Aspect 42. The method of any one of aspects 33-41, wherein the sulfone compound comprises at least one of: sulfolane, 3-methylsulfolane, dimethyl sulfone, ethyl methyl sulfone, or combinations thereof.

Aspect 43. The method of any one of aspects 33-42, wherein the sulfone compound comprises sulfolane, and the lithium salt comprises lithium bis(trifluoromethanesulfonyl)imide (LiTFSI).

Aspect 44. The method of any one of aspects 33-43, wherein the current collector comprises aluminum.

Aspect 45. The method of any one of aspects 33-44, wherein the cathode comprises at least one of lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0<d<1, 0<e<1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

Aspect 46. The method of any one of aspects 33-45, wherein a ratio of a weight of the cathode to an area of the first major surface is from about 1 mg/cm² to about 5 mg/cm².

Aspect 47. The method of any one of aspects 33-45, wherein a ratio of a volume of the interlayer to an area of the first major surface of the cathode from about 5 μL/cm² to about 20 μL/cm².

Aspect 48. The method of any one of aspects 33-47, wherein the solid-state electrolyte comprises lithium, lanthanum, zirconium, and oxygen.

Aspect 49. The method of aspect 48, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N═In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I═In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or a combination thereof.

Aspect 50. The method of any one of aspects 33-49, further comprising disposing an anode on the solid-state electrolyte, the solid-state electrolyte positioned between the cathode and the anode.

Aspect 51. A method of forming a battery comprising:
disposing an interlayer comprising a lithium salt and a sulfone compound on a first major surface of a cathode; and
disposing a solid-state electrolyte over the first major surface of the cathode, the interlayer positioned between the cathode and the solid-state electrolyte.

Aspect 52. The method of aspect 51, wherein an interfacial resistance between the cathode and the solid-state electrolyte, as-formed, is about 100 Ωcm² or less at 25° C.

Aspect 53. The method of aspect 51 wherein the battery comprises a capacity retention of about 70% or more after 250 cycles at 0.2 C with a cutoff voltage of 4.5V and at 25° C.

Aspect 54. The method of aspect 51, wherein a capacity retention is about 90% or more after 350 cycles at 0.2 C with a cutoff voltage of 4.6V and at 25° C.

Aspect 55. The method of aspect 51, wherein the battery comprises a capacity of about 140 mAh/g or more after 90 cycles at 0.2 C with a cutoff voltage of 4.5V and at 25° C.

Aspect 56. The method of any one of aspects 51-55, wherein the lithium salt comprises at least one of: lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof.

Aspect 57. The method of any one of aspects 51-56, wherein the sulfone compound comprises at least one of: sulfolane, 3-methylsulfolane, dimethyl sulfone, ethyl methyl sulfone, or combinations thereof.

Aspect 58. The method of any one of aspects 51-57, wherein the sulfone compound comprises sulfolane, and the lithium salt comprises lithium bis(trifluoromethanesulfonyl)imide (LiTFSI).

Aspect 59. The battery of any one of aspects 51-58, wherein a molar ratio of the lithium salt to the sulfone compound is about 0.125 or more.

Aspect 60. The battery of aspect 59, wherein the molar ratio of the lithium salt to the sulfone compound is from about 0.2 to about 1.

Aspect 61. The method of any one of aspects 51-60, wherein the current collector comprises aluminum.

Aspect 62. The method of any one of aspects 51-61, wherein the cathode comprises at least one of lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0<d<1, 0<e<1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

Aspect 63. The method of any one of aspects 51-62, wherein a ratio of a weight of the cathode to an area of the first major surface is from about 1 mg/cm² to about 5 mg/cm².

Aspect 64. The method of any one of aspects 51-62, wherein a ratio of a volume of the interlayer to an area of the first major surface of the cathode from about 5 μL/cm² to about 20 μL/cm².

Aspect 65. The method of any one of aspects 51-64, wherein the solid-state electrolyte comprises lithium, lanthanum, zirconium, and oxygen.

Aspect 66. The method of aspect 65, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N═In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I═In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or
a combination thereof.

Aspect 67. The method of any one of aspects 51-66, further comprising disposing an anode on the solid-state electrolyte, the solid-state electrolyte positioned between the cathode and the anode.

### BRIEF DESCRIPTION OF THE DRAWINGS

The above and other features and advantages of aspects of the present disclosure are better understood when the following detailed description is read with reference to the accompanying drawings, in which:

FIG. 1 schematically illustrates a general structure of a solid-state battery in accordance with aspects of the disclosure;

FIG. 2 illustrates a solid-state battery with an interlayer at the cathode/solid-state electrolyte interface;

FIG. 3 schematically illustrates a general structure of a solid-state battery in accordance with aspects of the disclosure;

FIG. 4 illustrates a solid-state battery with an interlayer at the cathode/solid-state electrolyte interface;

FIG. 5 illustrates a step in an exemplary method comprising disposing an interlayer on a cathode;

FIG. 6 illustrates a step in an exemplary method comprising disposing a solid-state electrolyte on the cathode;

FIG. 7 illustrates a step in an exemplary method comprising disposing a precursor solution on a cathode;

FIG. 8 illustrates a step in an exemplary method comprising curing the precursor solution to form the interlayer;

FIG. 9 illustrates a step in an exemplary method comprising disposing a solid-state electrolyte on the cathode;

FIG. 10 illustrates curves corresponding to thermogravimetric analysis (TGA) of lithium salts in solvents;

FIG. 11 illustrates curves correspond to linear sweep voltammetry (LSV) of different molar ratios of lithium bis(trifluoromethanesulfonyl)imide (LiTFSI) to sulfolane;

FIG. 12 illustrates a Nyquist plot for Example 6 before (as-formed) and after cycling;

FIG. 13 illustrates a Nyquist plot for Example 10 (as-formed);

FIG. 14 illustrates capacity retention for Example 7 at 25° C.;

FIG. 15 illustrates capacity retention for Example 9 at 25° C.;

FIG. 16 illustrates capacity retention for Example 7 at 25° C.;

FIG. 17 illustrates capacity retention for Example 9 at 25° C.;

FIG. 18 illustrates capacity retention for Example 10 at 45° C.; and

FIG. 19 illustrates capacity retention and Columbic efficiency for Example 11 at 45° C.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

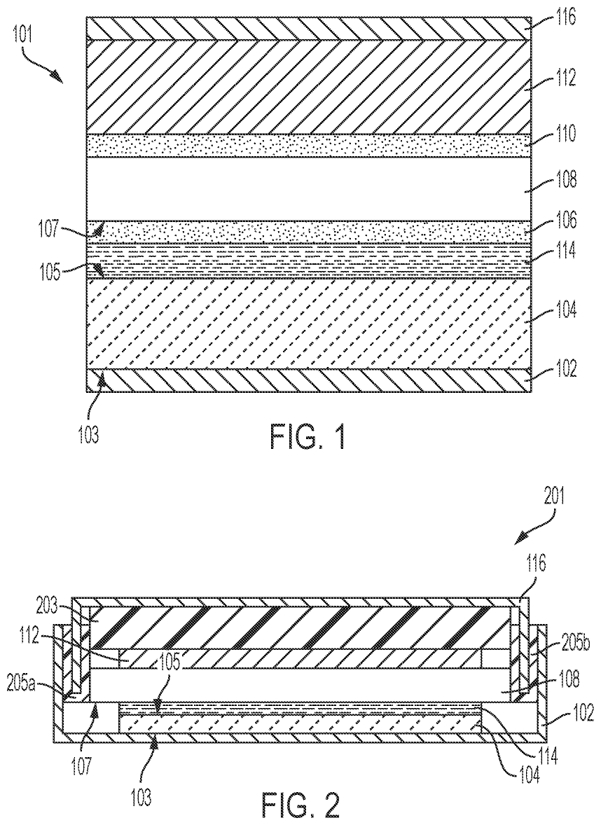

FIGS. 1-4 illustrate views of a solid-state battery 101 or 201 comprising an interlayer 114 or 314 positioned between a cathode 104 and a solid-state electrolyte 108 (e.g., the cathode/solid-state electrolyte interface) in accordance with aspects of the disclosure. In aspects, the interlayer 114 comprises a lithium salt and a sulfone compound. In aspects, the interlayer 314 comprises a lithium salt and a sulfone compound positioned within a polymeric matrix. Unless otherwise noted, a discussion of features of aspects of one foldable apparatus can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

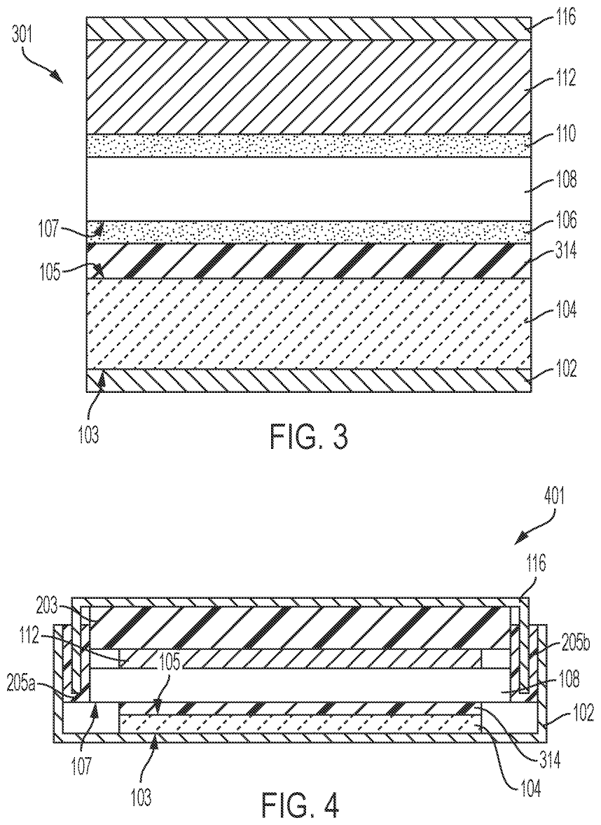

FIGS. 1 and 3 schematically illustrate a general structure of a solid-state battery 101 or 301, and FIGS. 2 and 4 illustrate a simplified solid-state battery 201 or 401 in a coin-cell form. As shown in FIGS. 1 and 3, the solid-state battery 101 or 301 can include, sequentially, a first current collector 102 (e.g., substrate), a cathode 104 disposed on the first current collector 102, an interlayer 114 or 314 disposed on the cathode 104, an optional first coating 106, a solid-state electrolyte 108, an optional second interlayer and/or second coating 110, an anode 112, and a second current collector 116 disposed on the anode 112. As shown in FIGS. 1 and 3, the solid-state battery 101 or 301 can optionally comprise a first coating 106 disposed on the cathode 104. The components of the solid-state battery 101 or 301 can be disposed horizontally in relation to each other or vertically.

The first current collector 102 comprises an electrically conductive material. As used herein, electrically conductive materials have an electronic conductivity of 100 Siemens per meter (S/m) measured at 25° C. in accordance with ASTME1004-17. In aspects, the first current collector can comprise nickel (Ni) foam, carbon fiber, or a solid metal contact (e.g., aluminum, stainless steel, copper, platinum, nickel, gold, zinc, cobalt, nickel, ruthenium, lithium, lead, titanium, nichrome, etc.). In aspects, the first current collector 102 can be a mechanically stable and/or dimensionally stable substrate that supports the other elements of the solid-state battery 101, 201, 301, or 401. In aspects, the first current collector 102 can comprise the same material as the cathode 104 (discussed below) such that the first current collector 102 is part of the cathode 104. An exemplary aspect of the current collector is aluminum, which can provide a low-cost current collector with good electrical conductivity (e.g., about 10⁶ S/m or more).

As shown in FIGS. 1-4, the cathode 104 comprises a first major surface 105 and a second major surface 103 opposite the first major surface 105. As shown, the first current collector 102 is disposed on and/or contacts the second major surface 103 of the cathode 104. The cathode 104 comprises an electrically conductive material. In aspects, the cathode 104 can be configured to release and reincorporate a cation (e.g., alkali metal—lithium or sodium, alkali earth metal—magnesium or calcium). In aspects, the cathode 104 can comprise at least one of an alkali metal (e.g., lithium, sodium) or an alkaline earth metal (e.g., magnesium, calcium). In aspects, the cathode 104 can comprise a fluoride compound. In further aspects, the cathode 104 can comprise at least one transition metal, for example, cobalt, manganese, nickel, niobium, tantalum, vanadium, titanium, copper, chromium, tungsten, molybdenum, tin, germanium, antimony, bismuth, iron, or combinations thereof. In aspects, the cathode 104 can comprise a lithium-based electrode, for example lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0<d<1, 0<e<1, for example, LiNi_{0.6}Co_{0.2}Mn_{0.2}O₂ (NCM622)), lithium iron phosphate (LiFePO₄) (LFP), lithium cobalt phosphate (LCP), lithium titanate, lithium niobium tungstate, lithium nickel manganate, lithium titanium sulfide (LiTiS₂), or combinations thereof. In aspects, the cathode 104 can comprise a sodium-based electrode, for example, NaVPO₄F, NaMnO₂, Na_{2/3}Mn_{1-y}Mg_{y}O₂ (0<y<1), Na₂Li₂Ti₅O₁₂, Na₂Ti₃O₇, or combinations thereof. In aspects, the cathode 104 can comprise a magnesium-based electrode, for example, magnesiochromite (MgCr₂O₄), MgMn₂O₄, or combinations thereof. An exemplary aspect of a cathode 104 is a NCM cathode.

In aspects, a ratio of a weight of the cathode 104 to an area of the first major surface 105 of the cathode 104 can be about 1 mg/cm² or more, about 2 mg/cm² or more, about 3 mg/cm² or more, about 10 mg/cm² or more, about 15 mg/cm² or more, about 30 mg/cm² or less, about 20 mg/cm² or less, about 10 mg/cm² or less, about 5 mg/cm² or less, about 4 mg/cm² or less, or about 3 mg/cm² or less. In aspects, a ratio of a weight of the cathode 104 to an area of the first major surface 105 of the cathode 104 can range from about 1 mg/cm² to about 5 mg/cm², from about 2 mg/cm² to about 4 mg/cm², from about 3 mg/cm² to about 4 mg/cm², or any range or subrange therebetween. Providing a cathode loading from about 1 mg/cm² to about 5 mg/cm² in combination with the interlayer described herein can make efficient use of cathode materials, for example, as demonstrated by the capacity in the Examples below. Alternatively, in aspects, the ratio of a weight of the cathode 104 to an area of the first major surface 105 of the cathode 104 can range from about 10 mg/cm² to about 30 mg/cm², from about 15 mg/cm² to about 20 mg/cm², or any range or subrange therebetween.

As shown in FIG. 1-4, the solid-state battery 101, 201, 301, or 401 comprises an interlayer 114 or 314 disposed on the first major surface 105 of the cathode 104. The interlayer 114 or 314 is positioned between the first major surface 105 of the cathode 104 and the solid-state electrolyte 108. The interlayer 114 or 314 functions as an electrolyte. As used herein, an “electrolyte” enables the transport of ions therein (“ion conductivity”), and the ion conductivity corresponds to an electrical conductivity of the electrolyte (e.g., interlayer). Providing an interlayer can decrease an interfacial resistance between the cathode 104 and the solid-state electrolyte 108. Compared to ionic liquid electrolytes, interlayers in accordance with the present disclosure can provide a lower-cost alternative that can be better suited for large-scale applications.

In aspects, the interlayer 114 or 314 comprises a lithium salt and a sulfone compound. In aspects, the lithium salt can comprise lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, lithium hexafluorophosphate (LiPF₆), lithium hexafluoroarsenate (LiAsF₆), lithium bis(oxalate)borate (LiBOB), lithium polysulfide, or combinations thereof. An exemplary aspect of the lithium salt is lithium bis(trifluoromethanesulfonyl)imide (LiTFSI). As used herein, “sulfone” means that the sulfone compound includes a sulfur atom bonded to two oxygen atoms and two organic functional groups. In aspects, the sulfone compound can comprise sulfolane, 3-methylsulfolane, dimethyl sulfone, ethyl methyl sulfone, benzidine sulfone, methoxyethyl methyl sulfone, ethyl vinyl sulfone, ethyl methoxyethyl sulfone, 1-fluoro-2-(methyl-sulfonyl)benzene, dipropyl sulfone, dibutyl sulfone, dimethoxy sulfone, diethoxy sulfone, methoxypropyl sulfone and phenylpropyl sulfone, or combinations thereof. Sulfolane is also known as tetramethylene sulfone. An exemplary aspect of the sulfone compound is sulfolane. An exemplary aspect of the lithium salt and a sulfone compound is lithium bis(trifluoromethanesulfonyl)imide (LiTFSI) and sulfolane.

In aspects, a molar ratio of the lithium salt to the sulfone compound can be about 0.125 (1:8) or more, about 0.143 (1:7) or more, about 0.167 (1:6) or more, about 0.20 (1:5) or more, about 0.25 (1:4) or more, about 1 (1:1) or less, about 0.5 or less (1:2), about 0.4 or less, or about 0.333 (1:3) or less. In aspects, a molar ratio of the lithium salt to the sulfone compound can range from about 0.125 to about 1, from about 0.143 to about 1, from about 0.167 to about 1, from about 0.20 to about 1, from about 0.25 to about 0.5, from about 0.25 to about 0.4, from about 0.25 to about 0.333, or any range or subrange therebetween. As demonstrated in the Examples discussed below, providing a molar ratio within one or more of the above-mentioned ranges can provide a thermally stable and/or oxidatively stable interlayer that can increase a longevity of the solid-state battery and/or increase a capacity retention of the solid-state battery.

In aspects, a ratio of a volume of the interlayer 114) in the solid-state battery 101, 201, 301, or 401 to an area of the first major surface 105 of cathode 104 can be about 5 μL/cm² or more, about 10 μL/cm² or more, about 15 μL/cm² or more, about 20 μL/cm² or less, about 18 μL/cm² or less, or about 15 μL/cm² or less. In aspects, a ratio of a volume of the interlayer 114 in the solid-state battery 101, 201, 301, or 401 to an area of the first major surface 105 of cathode 104 can range from about 5 μL/cm² to about 20 μL/cm², from about 10 μL/cm² to about 18 μL/cm², from about 12 μL/cm² to about 18 μL/cm², from about 15 μL/cm² to about 18 μL/cm², or any range or subrange therebetween. Providing a concentration of the lithium salt within one or more of the above-mentioned ranges can enable good ionic conductivity of the electrolyte interlayer. Providing the ratio of the volume of the electrolyte interlayer to the area of the first major surface of the cathode can be sufficient to wet the interface between the cathode and the solid-state electrolyte while minimizing concerns associated with traditional liquid electrolytes (e.g., in liquid-based batteries or in hybrid liquid-solid batteries).

In aspects, as shown in FIGS. 1-2, the interlayer 114 can comprise a liquid electrolyte. Throughout the disclosure, the liquid interlayer is a liquid at room temperature (i.e., 25° C.) and at an operating temperature of the corresponding solid-state battery (e.g., a temperature selected from 20° C. to 100° C.). In further aspects, the liquid electrolyte of the interlayer 114 can consist of the lithium salt and the sulfone compound. Providing the interlayer as a liquid electrolyte between the cathode 104 and the solid-state electrolyte (e.g., wetting the cathode/SSE interface) can provide continuous and uniform ion paths at the interface and inside the cathode, for example, due to the high ionic conductivity of the liquid electrolyte and the ability of the liquid electrolyte to conform to the first major surface 105 of the cathode 104 and/or a surface of the solid-state electrolyte 108. As demonstrated in the Examples discussed below, the liquid electrolyte interlayer of the present disclosure can enable reduced interfacial resistance (e.g., about 100 Ωcm² or less or about 50 Ωcm² or less at 25° C. as-formed, after 250 cycles, and/or after 350 cycles) and/or increased capacity retention (e.g., about 70% or more at 25° C. after 250 cycles or 350 cycles).

In aspects, as shown in FIGS. 3-4, the interlayer 314 can comprise a polymeric matrix. In further aspects, the polymeric matrix of the interlayer 314 the lithium salt and the sulfone compound can be positioned within the polymeric matrix. In even further aspects, the polymeric matrix can comprise an acrylic-based polymer. As used herein, an “acrylic-based polymer” comprises an acrylate functional group (R1-C(O)—O—R2), where R1 and R2 are organic functional groups. Throughout the disclosure, an “organic group” consists of atoms selected from a group consisting of carbon, hydrogen, oxygen, nitrogen, sulfur, phosphor, chlorine, and bromine. In still further aspects, R1 and R2 can comprise alkyl groups. As used herein, “alkyl” refers to unsaturated (i.e., without double bonds) functional groups consisting of combinations of carbon, hydrogen, and/or oxygen. In further aspects, the polymer can comprise a multifunctional monomer. Throughout the disclosure, a “polymer” comprises one or more repeat units referred to a “monomer.” As used herein, a “multifunctional monomer” comprises more than two functional groups that can be reacted with another monomer to form a covalent bond between the corresponding monomers. For example, the multifunctional monomer can be a tri-acrylate monomer. An exemplary aspect of a tri-acrylate monomer is ethoxylated trimethylolpropane triacrylate). Polymers made from a multifunctional monomer can be cross-linked, which can increase a viscosity of the interlayer. In further aspects, the polymeric matrix of the interlayer 314 can be a crosslinked polymeric matrix (e.g., crosslinked acrylic-based polymer). Providing a crosslinked polymeric matrix can increase a viscosity of the interlayer and/or decrease a mobility of the lithium salt therein, which can reduce a rate of degradation of the cathode current collector (e.g., first current collector 112). Providing a polymeric matrix in the interlayer can reduce an amount of the lithium salt and/or sulfone compound that can travel away from the interface between the cathode and the solid-state electrolyte, which can increase a capacity retention of the solid-state battery and/or decrease an interfacial resistance after cycling. As discussed below and as demonstrated in the Examples, providing a polymeric matrix (e.g., crosslinked polymeric matrix) interlayer can reduce corrosion of the first current collector by the lithium salt in the interlayer, which can enable increased operating temperatures, increased longevity, and/or increased capacity retention of the solid-state battery.

In aspects, the polymeric matrix, as a wt % of the interlayer 314, can be about 2 wt % or more, 5 wt % or more, about 6 wt % or more, about 7 wt % or more, about 20 wt % or less, about 15 wt % or less, about 12 wt % or less, 10 wt % or less, about 9 wt % or less, or about 8 wt % or less. In aspects, the polymeric matrix, as a wt % of the interlayer 314, can range from about 2 wt % to about 20 wt %, from about 2 wt % to about 15 wt %, from about 5 wt % to about 12 wt %, from about 5 wt % to about 10 wt %, from about 6 wt % to about 9 wt %, from about 7 wt % to about 8 wt %, or any range or subrange therebetween. Providing the polymeric matrix within one or more of the amounts mentioned in this paragraph can balance reducing the mobility of the lithium salt to reduce corrosion of the solid-state battery (e.g., first current collector) with a potential decrease in ionic conductivity of the interlayer.

As shown in FIGS. 1-4, the solid-state battery 101, 201, 301, or 401 comprise a solid-state electrolyte 108 comprising a second major surface 107 facing the first major surface 105 of the cathode 104 with the interlayer 114 positioned therebetween. The solid-state electrolyte 108 can be disposed on the interlayer 114. Throughout the disclosure, “solid-state batteries” comprise a solid-state electrolyte. As used herein, a solid-state electrolyte is a material that is solid at room temperature (i.e., 25° C.) and at an operating temperature (e.g., from about 20° C. to about 100° C.) of the solid-state battery. In aspects, the solid-state electrolyte 108 can comprise an inorganic solid-state electrolyte. Providing a solid-state electrolyte can address common safety concerns, for example, leakage, poor chemical stability, and flammability often seen in batteries employing liquid electrolytes. Moreover, providing a solid-state electrolyte can also suppress polysulfide shuttling from the cathode to the anode, thereby leading to improved cathode utilization and a high discharge capacity and energy density. Providing a solid-state electrolyte can reduce a formation of dendrites (e.g., lithium dendrites) that can otherwise result in failure of the battery.

In aspects, the solid-state electrolyte 108 can comprise lithium, lanthanum, zirconium, oxygen, or combinations thereof (e.g., each of lithium, lanthanum, zirconium, and oxygen—a LLZO compound). As used herein, “LLZO” refers to compounds including lithium, lanthanum, zirconium, and oxygen. In further aspects, the solid-state electrolyte 108 can comprise a lithium-garnet, for example, at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; (iii) Li_{7-c}La₃(Zr_{2-c},N_{c})O₁₂, with N═In, Si, Ge, Sn, V, W, Te, Nb, or Ta and 0<c<1; (iv) protonated LLZO (e.g., HₓLi_{6.5-x}La₃Zr_{1.5}I_{0.5}O₁₂, with I═In, Si, Ge, Sn, V, W, Te, Nb, or Ta and 0<x<4 or HₓLi_{6.25-x}E_{0.25}La₃Zr₂O₁₂, with E=Al, Ga or Fe and 0<x<4), or a combination thereof. In aspects, the solid-state electrolyte 108 can comprise at least one of Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof.

In aspects, the first coating 106 can comprise a carbon-based interlayer (e.g., interlinked freestanding, micro/mesopore containing, functionalized, biomass-derived), a polymer-based interlayer, a metal-based coating (e.g., Ni foam, etc.), a liquid electrolyte (e.g., LiPF₆ in ethylene carbonate (EC)/dimethyl carbonate (DMC)), ionic liquid-based (e.g., LiCF₃SO₃/CH₃CONH₂, LiTFSI/N-methylacetamide (NMA), PEG₁₈LiTFSI-10% SiO₂-10% IL, etc., where LiTFSI is bis(trifluoromethane) sulfonimide lithium salt (LiN(CF₃SO₂)₂), SiO₂ may be nanoparticles, and IL is an ionic liquid), or a combination thereof. Exemplary aspects of polymer-based interlayers include carbon polysulfides (CS), polyethylene oxides (PEO), polyaniline (PANI), polypyrrole (PPY), poly(3,4-ethylenedioxythiophene) (PEDOT), poly(styrene sulfonic acid) (PSS), polyacrylonitrile (PAN), polyacrylic acid (PAA), polyallylamine hydrochloride (PAH), poly(vinylidene fluoride-co-hexafluoropropylene) (P(VDF-co-HFP)), poly(methyl methacrylate) (PMMA), polyvinylidene fluoride (PVDF), poly(diallyldimethyl ammonium) bis(trifluoromethanesulfonyl)imide (TFSI) (PDDATFSI), or combinations thereof. In aspects, the first coating 106 can comprise at least one of, or at least two of, or at least three elements selected from a group consisting of nitrogen, carbon, cobalt, titanium, tantalum, and tungsten.

In aspects, the optional second interlayer or second coating 110 can comprise the materials or aspects discussed above the first coating 106 and/or the interlayer 114. In aspects, the optional second interlayer or second coating 110 can comprise an anode protector, for example, electrolyte additives (e.g., LiNO₃, lanthanum nitrate, copper acetate, P₂S₅, etc.), artificial interfacial layers (e.g., LiN, (CH₃)₃SiCl, Al₂O₃, LiAl, etc.), composite metallics (e.g., Li₇B₆, Li-rGO (reduced graphene oxide), layered Li-rGO, etc.), or combinations thereof. In aspects, the optional second interlayer or second coating 110 can comprise a thin layer of metal (e.g., Au) that may be ion-sputter coated to form a contact interface between the anode 112 the solid-state electrolyte 108 and another material of the optional second interlayer or second coating 110 or and another material of the optional second interlayer or second coating 110. In aspects, the optional second interlayer or second coating 110 can comprise a thin layer of silver (Ag) paste may be brushed on a surface of the solid-state electrolyte 108 (e.g., opposite the second major surface 107) to form a close contact between the anode 112 and solid-state electrolyte 108.

As shown in FIGS. 1-2, the anode 112 can be disposed on the solid-state electrolyte 108. The anode 112 comprises lithium. In aspects, the anode can comprise, consist essentially of, and/or consist of lithium (Li) metal.

FIG. 2 illustrates a solid-state battery 201 with the interlayer 114 comprising a liquid electrolyte at the cathode/solid-state electrolyte interface, and FIG. 4 illustrates a solid-state battery 401 with the interlayer 314 comprising the polymeric matrix. As shown in FIGS. 2 and 4, the solid-state battery 201 or 401 can comprise a coin-cell form, although the battery can comprise another form in other aspects. Compared to FIGS. 1 and 3, FIGS. 2 and 4 show a simplified solid-state battery 201 or 401 because the first coating 106 and the optional second interlayer or second coating 110 are omitted. Consequently, the interlayer 114 or 314 is in direct contact with the first major surface 105 of the cathode 104 and the second major surface 107 of the solid-state electrolyte 108. In aspects, as shown, the area of the first major surface 105 of the cathode 104 can be less than or equal to (e.g., less than) the area of the second major surface of the solid-state electrolyte 108. In aspects, the first current collector 102 and/or the second current collector 116 can comprise an outer surface of the solid-state battery 201 or 401. In further aspects, an electrically insulating layer 205a and 205b can be positioned between the first current collector 102 and the second current collector 116 to prevent a short circuit in the solid-state battery 201 or 401 and/or to form a barrier protecting the contents of the solid-state battery 201 or 401. As used herein, the electrically insulating layer 205a and 205b comprises an electronic conductivity of 10⁵ S/cm or less. In even further aspects, as shown, the electrically insulating layer 205a and 205b can be configured to maintain a configuration of the solid-state battery 201 or 401, for example, by preventing the solid-state electrolyte 108 from contacting the second current collector 116. In further aspects, the electrically insulating layer 205a and 205b can comprise a polymeric material, for example, a fluoropolymer, a rubber, a polyurethane, or a silicone. In aspects, as shown, the solid-state battery 201 or 401 can further comprise an electrically conductive spacer 203 positioned between the anode 112 and the second current collector 116. In further aspects, the electrically conductive spacer 203 can comprise a foam (e.g., Ni foam), which can help maintain contact between adjacent components of the solid-state battery and/or control an amount of stress that the components of the solid-state battery are subjected to. Although not shown, an electrically conductive spacer can be positioned between the cathode and the first current collector.

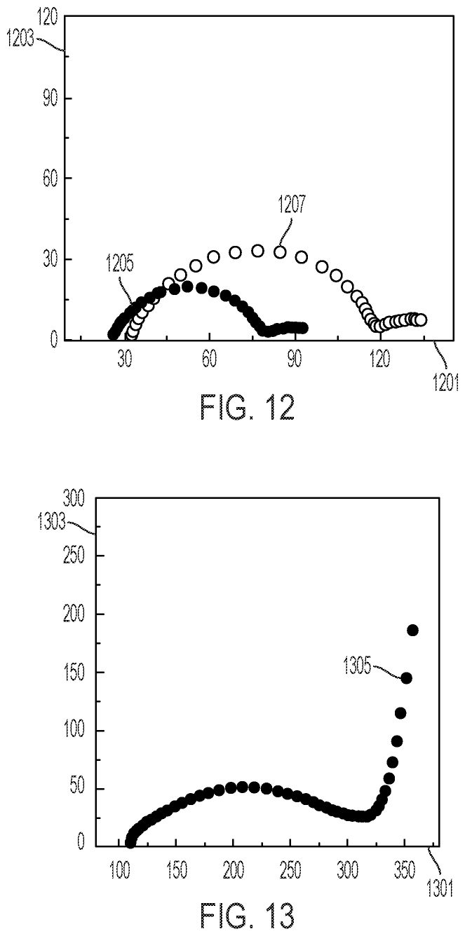

FIGS. 12-13 illustrate Nyquist plots measured at 25° C., where the horizontal axis 1201 corresponds to the real component of impedance (Z′ measured in Ωcm²) and the vertical axis 1203 corresponds to the negative imaginary component of impedance (Z″ measured in Ωcm²) for frequencies from 0.1 Hertz (Hz) to 1 MegaHertz (MHz). Throughout the disclosure, Nyquist plots were measured at 25° C. using an Autolab PGSTAT320N (Metrohm, Netherlands). Curves 1205 and 1207 correspond to the impedance of an interlayer in accordance with the aspects of the disclosure measured with two lithium metal electrodes initially (as-formed) and after cycling for 3,000 seconds at 0.2 C between 2.8V and 4.5V at 25° C., respectively. Unless otherwise indicated, a cycle corresponds to a charge-discharge cycle at 0.2 C with a cutoff voltage of 4.5 V while the solid-state battery is maintained at 25° C. Curves 1205 and 1207 have a well-defined arc (e.g., semi-circular) portion. Throughout the disclosure, “interfacial resistance” is defined as the difference between the real components of the impedance for the end-points of the arc shape in impedance results (i.e., Nyquist plot), where the higher end-point is taken as an inflection point in the impedance results. For example, the interfacial resistance of curve 1205 is 42 Ωcm², and the interfacial resistance of curve 1207 is 95 Ωcm² after cycling, as described above, which are interfacial resistances for the interlayer (alone). Throughout the disclosure, the interfacial resistance of the interlayer (alone) is measured from a Nyquist plot obtained for an interlayer sandwiched between two stainless steel electrodes at 25° C. As used herein, “as-formed” means that the cell (e.g., solid-state battery) to be tested has been fully assembled but has not yet been cycled. In aspects, the interfacial resistance of the interlayer (as-formed) can be about 300 Ωcm² or less, about 250 Ωcm² or less, about 210 Ωcm² or less, about 100 Ωcm² or less, about 50 Ωcm² or less, about 10 Ωcm² or more, about 20 Ωcm² or more, about 30 Ωcm² or more, about 40 Ωcm² or more, about 100 Ωcm² or more, about 200 Ωcm² or more, or about 210 about 200 Ωcm² or more. In aspects, the interfacial resistance of the interlayer (as-formed) can range from about 10 Ωcm² to about 300 Ωcm², from about 20 Ωcm² to about 250 Ωcm², from about 30 Ωcm² to about 210 Ωcm², from about 30 Ωcm² to about 100 Ωcm², from about 40 Ωcm² to about 50 Ωcm², or any range or subrange therebetween. In aspects, the interfacial resistance of the interlayer 114 comprising the liquid electrolyte can range from about 10 Ωcm² to about 100 Ωcm², from about 20 Ωcm² to about 50 Ωcm², from about 30 Ωcm² to about 50 Ωcm², from about 40 Ωcm² to about 50 Ωcm², or any range or subrange therebetween. In aspects, the interfacial resistance of the interlayer 314 comprising the polymeric matrix can range from about 40 Ωcm² to about 300 Ωcm², from about 100 Ωcm² to about 250 Ωcm², from about 200 Ωcm² to about 210 Ωcm², or any range or subrange therebetween. In aspects, after 50 cycles, as described above at 0.2 C to a cutoff voltage of 4.5V at 25° C., the interfacial resistance of the interlayer can be within one or more of the ranges discussed above in this paragraph for the interfacial resistance of the interlayer (as-formed).

Throughout the disclosure, the interfacial resistance of the interlayer in the solid-state battery (i.e., “interfacial resistance of the solid-state battery”) is measured from a Nyquist plot obtained for an interlayer sandwiched between a cathode and a solid-state electrolyte with an anode disposed on the solid-state electrolyte in the structure shown in FIGS. 2 and 4 and described below for Examples 6-10 at 25° C. unless another temperature is specified. Curve 1305 corresponds to the impedance of a solid-state battery (Example 10, described below) resembling the solid-state battery 401 shown in FIG. 4 measured as-formed at 25° C. Curve 1305 also has a well-defined arc shape with an interfacial resistance of 210 Ωcm². In aspects, the interfacial resistance of the solid-state battery, either as-formed or after 50 cycles (at 0.2 C to a cutoff voltage of 4.5V at 25° C.), can be within one or more of the ranges discussed above in the previous paragraph for the interfacial resistance of the interlayer. The interfacial resistance of interlayers and solid-state batteries containing the same in accordance with aspects of the disclosure can be reduced by more than one order of magnitude (e.g., 100× or more, 1000× or more) than a solid-state battery without an interlayer, which can have an interfacial resistance on the order of 100,000 Ωcm². Providing and/or maintaining a low (e.g., about 300 Ωcm² or less, about 100 Ωcm² or less) interfacial resistance of the interlayer and/or the solid-state battery can enable the solid-state battery to have a longer life (e.g., withstand more cycles without failure), reduce losses and heating from increased interfacial resistance, and/or reduce the formation of dendrites (e.g., lithium dendrites) that can lead to failure of the solid-state battery.

Throughout the disclosure, “capacity” refers to the charge stored in a battery when charged at 0.2 C to cutoff voltage of 4.5V at 25° C. unless another temperature is specified, and the capacity is measured as milliAmp-hours per gram of cathode (e.g., cathode active material) (mAh/g). In aspects, the solid-state battery can comprise As used herein, “as-formed capacity” is measured on the second cycle rather than the first cycle. In aspects, the solid-state battery can comprise an as-formed capacity of about 100 mAh/g or more, about 140 mAh/g or more, about 150 mAh/g or more, about 160 mAh/g or more, about 180 mAh/g or more, about 190 mAh/g or more, about 300 mAh/g or less, about 250 mAh/g or less, about 220 mAh/g or less, about 200 mAh/g or less, about 190 mAh/g or less, or about 180 mAh/g or less. In aspects, the solid-state battery can comprise an as-formed capacity ranging from about 100 mAh/g to about 300 mAh/g, from about 140 mAh/g to about 250 mAh/g, from about 160 mAh/g to about 220 mAh/g, from about 180 mAh/g to about 200 mAh/g, or any range or subrange therebetween. In aspects, the solid-state battery can comprise a capacity after 250 cycles at 0.2 C with a cutoff voltage of 4.6V and at 25° C. that is within one or more of the above-mentioned ranges in this paragraph. In aspects, the solid-state battery can comprise a capacity after 350 cycles (at 0.2 C with a cutoff voltage of 4.5V and at 25° C.) within one or more of the above-mentioned ranges in this paragraph. For example, the solid-state battery can comprise a capacity after 250 cycles (at 0.2 C with a cutoff voltage of 4.6V and at 25° C.) and/or after 350 cycles (at 0.2 C with a cutoff voltage of 4.5V and at 25° C.) ranging from about 100 mAh/g to about 250 mAh/g, from about 140 mAh/g to about 200 mAh/g, from about 140 mAh/g to about 190 mAh/g, from about 150 mAh/g to about 180 mAh/g, or any range or subrange therebetween. In aspects, the solid-state battery comprising the interlayer 314 with the polymeric matrix can comprise an as-formed capacity and/or a capacity after 90 cycles at 45° C. (at 0.2 C with a cutoff voltage of 4.5V and at 45° C.) ranging from about 100 mAh/g to about 300 mAh/g, from about 140 mAh/g to about 250 mAh/g, from about 150 mAh/g to about 220 mAh/g, from about 160 mAh/g to about 200 mAh/g, from about 170 mAh/g to about 190 mAh/g, or any range or subrange therebetween. Providing and/or maintaining a high capacity (e.g., 150 mAh/g or more as-formed or after 250 cycles or after 350 cycles at 25° C., 140 mAh/g or more as-formed or after 90 cycles at 45° C.,) can enable the solid-state battery to make efficient use of cathode materials (e.g., for an intended use for a longer period of time) than would otherwise be possible.

Throughout the disclosure, “capacity retention” refers to the percent of an as-formed capacity that the solid-state battery can achieve after a predetermined cycle using the same charge-discharge cycle for all cycles. Unless otherwise specified, as discussed above, a cycle corresponds to a charge-discharge cycle at 0.2 C with a cutoff voltage of 4.5 V while the solid-state battery is maintained at 25° C. In aspects, a solid-state battery comprising the interlayer 114 can comprise a capacity retention after 250 cycles at 0.2 C with a cutoff voltage of 4.6V and at 25° C. of about 70% or more, about 75% or more, about 80% or more, about 85% or more, about 95% or less, about 90% or less, or about 85% or less. In aspects, the solid-state battery comprising the interlayer 114 can comprise a capacity retention after 250 cycles at 0.2 C with a cutoff voltage of 4.6V and at 25° C. ranging from about 70% to about 95%, from about 75% to about 90%, from about 80% to about 90%, from 85% to about 90%, or any range or subrange therebetween. In aspects, the solid-state battery comprising the interlayer 114 can comprise a capacity retention after 350 cycles (at 0.2 C with a cutoff voltage of 4.5V and at 25° C.) of about 70% or more, about 80% or more, about 90% or more, about 92% or more about 99% or less, about 97% or less, about 95% or less, or about 93% or less. In aspects, the solid-state battery comprising the interlayer 114 can comprise a capacity retention after 350 cycles (at 0.2 C with a cutoff voltage of 4.5V and at 25° C.) ranging from about 70% to about 99%, from about 80% to about 97%, from about 90% to about 95%, from about 92% to about 93%, or any range or subrange therebetween. In aspects, the solid-state battery comprising the interlayer 314 with the polymeric matrix can comprise capacity retention after 90 cycles at 45° C. (at 0.2 C with a cutoff voltage of 4.5V and at 45° C.) of about 90% or more, about 91% or more, about 92% or more, about 99% or less, about 95% or less, or about 93% or less. In aspects, the solid-state battery comprising the interlayer 314 with the polymeric matrix can comprise capacity retention after 90 cycles at 45° C. (at 0.2 C with a cutoff voltage of 4.5V and at 45° C.) ranging from about 90% to about 99%, from about 91% to about 95%, from about 92% to about 93%, or any range or subrange therebetween. Maintaining a high capacity retention (e.g., (e.g., 70% or more after 250 cycles at 25° C., 90% or more after 350 cycles at 25° C., 90% or more after 90 cycles at 45° C.) can enable the solid-state battery to be functional for an intended use for a longer period of time than would otherwise be possible.

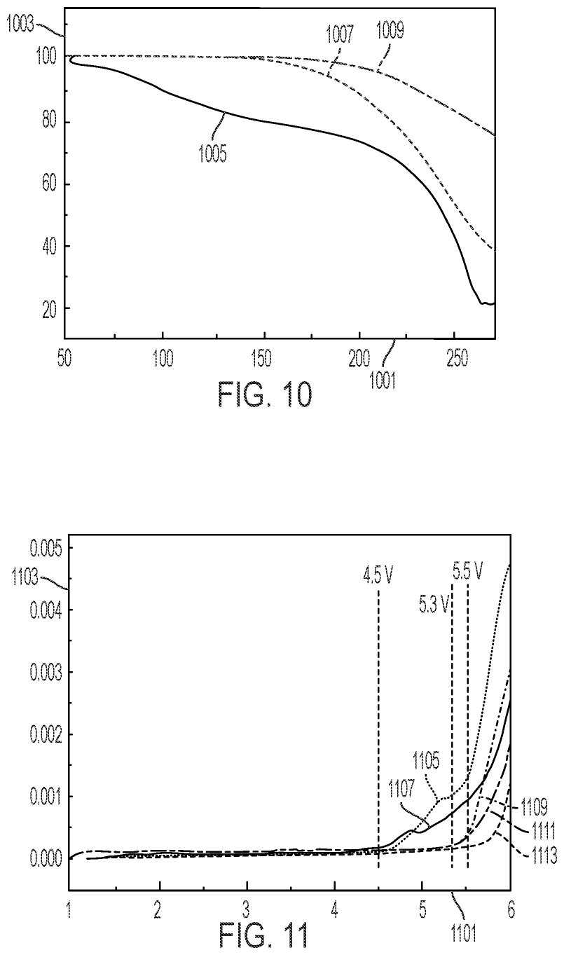

Throughout the disclosure, a “thermally stable” interlayer comprises a mass loss of 5 wt % or less based on thermogravimetric analysis (TGA) from 25° C. to a predetermined temperature at a heating rate of 10° C./min. As used herein, TGA is conducted with a Netzsch STA 409PC Luxx (Netzsch-Geratebau GmbH). In aspects, the interlayer 114 or 314 can be thermally stable to a temperature of 100° C. or more, about 120° C. or more, about 140° C. or more, about 160° C. or more, or about 175° C. or more, or about 190° C. or more. As discussed below in the Examples with reference to FIG. 10, interlayers comprising LiTFSI and sulfolane were thermally stable to 175° C. (curves 1007 and 1009) and to 1900 (curve 1009) while curve 1005 (Comparative Example A) is not thermally stable at even 100° C. Providing a thermally stable interlayer (e.g., to 100° C. or more, about 150° C. or more, about 175° C. or more) can increase a range of operating temperatures for the solid-state battery, increase a capacity retention of the solid-state battery, and/or increase a longevity of the solid-state battery.

Throughout the disclosure, an “oxidation potential” of an interlayer is measured using linear sweep voltammetry (LSV) at 5 milliVolts (mV) per second (mV/s) as a potential at which there is an inflection point in current corresponding to be beginning of a sharp increase in current detected from the interlayer. As used herein, the oxidation potential is measured by positioning the interlayer between one stainless steel electrode and one lithium metal electrode. In aspects, the interlayer can comprise an oxidation potential of about 4.5V or more, about 5 V or more, about 5.3 V or more, about 5.4 V or more, or about 5.5 V or more. As discussed below in the Examples with reference to FIG. 11, the interlayers of Examples 1-5 comprise an oxidation potential of 4.5 V or more, Examples 3-5 comprise an oxidation potential of 5.3 V or more, and Example 5 comprises an oxidation potential of 5.5V. Providing a high oxidation potential of an interlayer (e.g., about 4.5 V or more, about 5 V or more, about 5.3 V or more) can enable increased capacity (e.g., charging to higher voltages), increased capacity retention of the solid-state battery (e.g., through decreased degradation of the interlayer), and/or increased longevity of the solid-state battery. Also, some lithium salts in the interlayer can corrode other parts of the solid-state battery (e.g., first current collector), which can be accelerated at increased temperatures (e.g., 40° C. or more) and/or increased charging voltage cutoffs (e.g., about 4 V or more). Providing an interlayer with an increased oxidation potential (e.g., about 4.5 V or more, about 5 V or more, about 5.3 V or more) can enable the solid-state battery to operate at increased temperatures (e.g., greater than 25° C., 40° C. or more) and/or increased charging volage cutoffs (e.g., 4.5 V or more) without increased corrosion of the solid-state battery. Additionally, providing an interlayer comprising a polymeric matrix can further reduce a corrosion of components of the solid-state battery (e.g., first current collector) can decrease a mobility of the lithium salt contained therein and/or that decrease an amount of the lithium salt can travel away from the interface between the cathode and the solid-state electrolyte.

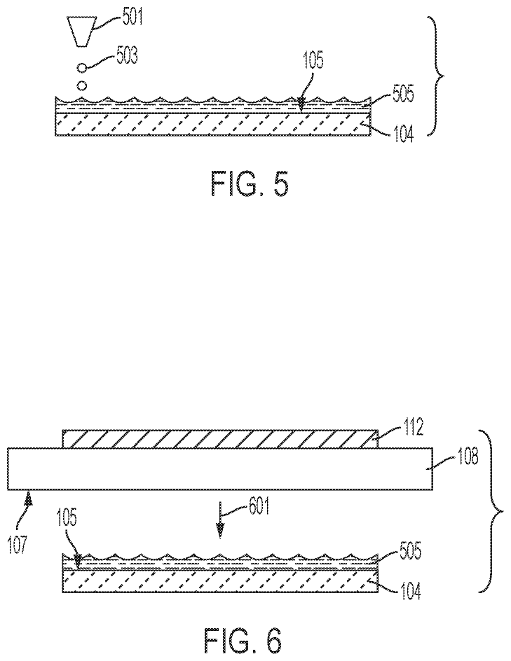

Aspects of methods of making the solid-state battery in accordance with aspects of the disclosure will be discussed with reference to example method steps illustrated in FIGS. 5-8. A first set of methods of making the solid-state battery corresponding to FIGS. 1-2 will be described with reference to the example method steps illustrated in FIGS. 5-6. In aspects, as shown in FIG. 5, methods can comprise disposing an interlayer 503 comprising the lithium salt and the sulfone compound on the first major surface 105 of the cathode 104. The cathode 104 can comprise any of the aspects discussed above for the cathode 104. In aspects, the interlayer 503 can comprise lithium bis(trifluoromethanesulfonyl)imide (LiTFSI) as the lithium salt and sulfolane as the sulfone compound. In aspects, a ratio of a weight of the cathode 104 to an area of the first major surface 105 of the cathode 104 can range from about 1 mg/cm² to about 5 mg/cm², from about 2 mg/cm² to about 4 mg/cm², from about 3 mg/cm² to about 4 mg/cm², or any range or subrange therebetween. The interlayer 503 can comprise any of the aspects discussed above for the interlayer 114. In further aspects, as shown, disposing the interlayer 503 can comprise dispensing a predetermined amount of the interlayer 503 from a container 501 (e.g., conduit, flexible tube, micropipette, or syringe) to form a layer 505 on the first major surface 105 of the cathode 104. In further aspects, the predetermined amount of the interlayer as a ratio of a volume of the interlayer to an area of the first major surface of the cathode can range from about 5 μL/cm² to about 20 μL/cm², from about 10 μL/cm² to about 18 μL/cm², from about 12 μL/cm² to about 18 μL/cm², from about 15 μL/cm² to about 18 μL/cm², or any range or subrange therebetween. In further aspects, a molar ratio of the lithium salt to the sulfone compound can be within one or more of the corresponding ranges discussed above, for example, from about 0.125 to about 1, from about 0.143 to about 1, from about 0.167 to about 1, from about 0.20 to about 1, from about 0.25 to about 0.5, from about 0.25 to about 0.4, from about 0.25 to about 0.333, or any range or subrange therebetween. Providing the ratio of the volume of the interlayer to the area of the first major surface of the cathode can be sufficient to wet the interface between the cathode and the solid-state electrolyte while minimizing concerns associated with traditional liquid electrolytes (e.g., in liquid-based batteries or in hybrid liquid-solid batteries). Although not shown, the cathode can be disposed on the first current collector while the interlayer is disposed on the cathode.

In aspects, as shown in FIG. 6, methods can proceed to disposing the solid-state electrolyte 108 over the first major surface 105 of the cathode 104, as indicated by arrow 601. The solid-state electrolyte 108 can comprise any of the aspects discussed above for the solid-state electrolyte 108. In further aspects, as shown, the second major surface 107 of the solid-state electrolyte 108 can face the first major surface 105 of the cathode 104 with the layer 505 positioned therebetween. Disposing the solid-state electrolyte 108 over the first major surface 105 of the cathode 104 can form the layer 505 into the interlayer 114 shown in FIGS. 1-2. As shown, the anode 112 can be disposed on the solid-state electrolyte 108 while the solid-state electrolyte 108 is disposed over the first major surface 105 of the cathode 104. Although not shown, the anode could be disposed on the solid-state electrolyte after the solid-state electrolyte is disposed on the cathode. Although not shown, it is to be understood that elements (e.g., second current collector, optional second interlayer or coating, electrically conductive spacer) can be disposed on the solid-state electrolyte opposite the second major surface while the solid-state electrolyte is disposed over the first major surface of the cathode. Alternatively, the anode can be disposed on the solid-state electrolyte after the solid-state electrolyte is disposed over the cathode. Although not shown, it is to be understood that methods of making the solid-state battery can comprise (1) disposing the interlayer comprising the lithium salt and the sulfone compound on the second major surface of the solid-state electrolyte and (2) disposing the cathode (e.g., first major surface) over the second major surface of the solid-state electrolyte. However, when the area of the first major surface is less than an area of the second major surface, more of the interlayer is at the interface when the interlayer is disposed on the cathode instead of the solid-state electrolyte.

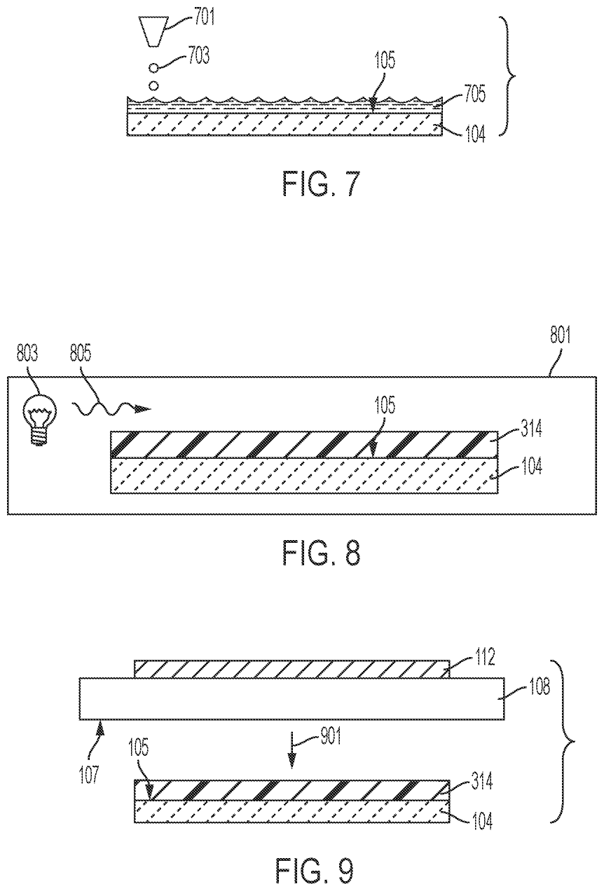

A second set of methods of making the solid-state battery corresponding to FIGS. 3-4 will be described reference to the exemplary method steps illustrated in FIGS. 7-9. In aspects, as shown in FIG. 7, methods can comprise disposing a precursor solution 703 comprising the lithium salt, the sulfone compound, and a monomer on the first major surface 105 of the cathode 104. The cathode 104 can comprise any of the aspects discussed above for the cathode 104. In aspects, a ratio of a weight of the cathode 104 to an area of the first major surface 105 of the cathode 104 can range from about 1 mg/cm² to about 5 mg/cm², from about 2 mg/cm² to about 4 mg/cm², from about 3 mg/cm² to about 4 mg/cm², or any range or subrange therebetween. The lithium salt and/or the sulfone compound of the precursor solution 703 can comprise any of the corresponding materials or aspects discussed above for the interlayer 314. In further aspects, as shown, disposing the precursor solution 703 can comprise dispensing a predetermined amount of the precursor solution 703 from a container 701 (e.g., conduit, flexible tube, micropipette, or syringe) to form a layer 705 on the first major surface 105 of the cathode 104. In aspects, the monomer of the precursor solution is an acrylate monomer and/or a multi-functional monomer. In aspects, the monomer, as a wt % of the precursor solution, can range from about 5 wt % to about 10 wt %, from about 6 wt % to about 9 wt %, from about 7 wt % to about 8 wt %, or any range or subrange therebetween. In aspects, the precursor solution 703 can optionally comprise a photoinitiator, as wt % of the precursor solution, of greater than 0% to about 1 wt %, from about 0.02 wt % to about 0.5 wt %, from about 0.05 wt % to about 0.2 wt %, from about 0.07 wt % to about 0.1 wt %, or any range or subrange therebetween. In further aspects, the initiator can comprise a free radical photoinitiator, for example, azodiisobutyronitrile (AIBN). In aspects, the predetermined amount of the precursor solution as a ratio of a volume of the interlayer to an area of the first major surface of the cathode can range from about 5 μL/cm² to about 20 μL/cm², from about 10 μL/cm² to about 18 μL/cm², from about 12 μL/cm² to about 18 μL/cm², from about 15 μL/cm² to about 18 μL/cm², or any range or subrange therebetween. Although not shown, the cathode can be disposed on the first current collector while the interlayer is disposed on the cathode.

In aspects, as shown in FIG. 8, methods can proceed to curing the precursor solution (e.g., layer 705 in FIG. 7) to form the interlayer 314. In further aspects, as shown in FIG. 8, curing the precursor solution can comprise heating the precursor solution and the cathode 104 at a predetermined temperature for a predetermined period of time, for example, by placing the precursor solution and the cathode 104 in an oven 801. In even further aspects, the predetermined temperature can range from about 40° C. to about 100° C., from about 60° C. to about 80° C., or any range or subrange therebetween. In even further aspects, the predetermined period of time can range from about 5 minutes to about 6 hours, from about 8 minutes to about 2 hours, from about 10 minutes to about 60 minutes, from about 10 minutes to about 30 minutes, from about 15 minutes to about 20 minutes, or any range or subrange therebetween. Alternatively, in further aspects, as shown, curing the precursor solution can comprise irradiating the precursor solution with radiation 805 emitted from a radiation source 803 to form the interlayer 314, for example, when the precursor solution comprises a photoinitiator. The radiation source 803 can comprise a light-emitting diode (LED), an organic light-emitting diode (OLED), a laser, an incandescent bulb, and/or a fluorescent bulb (e.g., a cold cathode fluorescent lamp (CCFL)). The radiation source 803 can be configured to emit radiation 805 comprising one or more wavelengths that the photoinitiator is sensitive to.

In aspects, as shown in FIG. 9, methods can proceed to disposing the solid-state electrolyte 108 over the first major surface 105 of the cathode 104, as indicated by arrow 901. The solid-state electrolyte 108 can comprise any of the aspects discussed above for the solid-state electrolyte 108. In further aspects, as shown, the second major surface 107 of the solid-state electrolyte 108 can face the first major surface 105 of the cathode 104 with the interlayer 314 positioned therebetween. As shown, the anode 112 can be disposed on the solid-state electrolyte 108 while the solid-state electrolyte 108 is disposed over the first major surface 105 of the cathode 104. Although not shown, the anode could be disposed on the solid-state electrolyte after the solid-state electrolyte is disposed on the cathode. Although not shown, it is to be understood that elements (e.g., second current collector, optional second interlayer or coating, electrically conductive spacer) can be disposed on the solid-state electrolyte opposite the second major surface while the solid-state electrolyte is disposed over the first major surface of the cathode. Alternatively, the anode can be disposed on the solid-state electrolyte after the solid-state electrolyte is disposed over the cathode. Although not shown, it is to be understood that methods of making the solid-state battery can comprise (1) disposing the interlayer comprising the lithium salt and the sulfone compound on the second major surface of the solid-state electrolyte and (2) disposing the cathode (e.g., first major surface) over the second major surface of the solid-state electrolyte. However, when the area of the first major surface is less than an area of the second major surface, more of the interlayer is at the interface when the interlayer is disposed on the cathode instead of the solid-state electrolyte.

### EXAMPLES

Various aspects will be further clarified by the following examples. Examples (Ex) 1-5 and Comparative Example A comprised an interlayer comprising a liquid electrolyte between stainless steel plates for measuring interfacial resistance of the interlayer at 25° C., as shown in Table 1. Examples (Ex) 6-9 comprised a solid-state battery resembling solid-state battery 201 shown in FIG. 2 with an interlayer comprising a liquid electrolyte at 25° C. with the properties of Examples 6-9 shown in Table 2. Example 10 comprised a solid-state battery resembling solid-state battery 401 shown in FIG. 4 with an interlayer comprising a polymeric matrix at 45° C. Example 11 comprises a solid-state battery resembling solid-state battery 201 shown in FIG. 2 with an interlayer comprising a liquid electrolyte at 45° C. The properties of Examples 10-11 are shown in Table 3.

### Examples 1-5 and Comparative Example A

The interlayers of Examples 1-5 and Comparative Example A were formed by dissolving the lithium salt in sulfolane (Examples 1-5) or a 1:1 volume mixture of ethylene carbonate and dimethyl carbonate (Comparative Example A) at 25° C. For Examples 1-5, the lithium salt was LiTFSI and the molar ratio of LiTFSI to sulfolane is provided in Table 1. For Comparative Example A, the interlayer comprised 1 molar (M) LiPF₆ in the 1:1 volume mixture of ethylene carbonate and dimethyl carbonate.

FIG. 10 presents TGA results for Example 1, Example 5, and Comparative Example 5. As discussed above, the TGA was conducted using a Netzsch STA 409PC Luxx (Netzsch-Geratebau GmbH) starting at 25° C. with the temperature increased at 10° C./min. In FIG. 10, the horizontal axis 1001 corresponds to temperature in ° C., and the vertical axis 1003 is the wt % of the sample remaining. Curve 1005 corresponds to the results for Comparative Example A. Curve 1005 already lost mass at 50° C., lost 10 wt % by 100° C., and lost 20 wt % at 150° C. This demonstrates that Comparative Example A is not suitable for operating temperatures much above room temperature (e.g., 45° C. or more) and can represent a flammability risk because of a high vapor pressure that can be associated with liquid materials that lose mass over an extended temperature range. Curves 1007 and 1009 correspond to Examples 1 and 5, respectively. Curves 1007 and 1009 maintain substantially 100 wt % beyond 100° C. (and beyond 150° C. for curve 1009). Also, curves 1007 and 1009 demonstrate a mass loss of 5% or less (thermally stable) at temperatures of 150° C. or more or 175° C. or more; curve 1009 further demonstrates that Example 5 is thermally stable at 190° C. Both curves 1007 and 1009 demonstrate that Examples 1 and 5 are thermally stable at temperatures much higher than Comparative Example A, as indicated by curve 1005. Further, the increased thermal stability of Example 1 (curve 1009) indicates that higher molar ratios can provide a benefit of increased thermal stability.

Table 1 presents the contact resistance, and ionic conductivity that were measured for Examples 1-5 by sandwiching the interlayer between two stainless steel electrodes, where a ratio of a volume of the interlayer to a surface area of one of the stainless steel electrodes is about 17.7 μL/cm². The oxidation potential presented in Table 1 was measured for Examples 1-5 by sandwiching the interlayer between one stainless steel electrode and one lithium metal electrode, where a ratio of a volume of the interlayer to a surface area of one of the stainless steel electrodes is about 17.7 μL/cm². As described above, the oxidation potential was measured using LSV at 25° C. FIG. 11 presents the result of LSV for Examples 1-5. In FIG. 11, the horizontal axis 1101 is voltage in Volts, and the vertical axis is current in Amps. Curves 1105, 1107, 1109, 1111, and 1113 correspond to Examples 1-5, respectively. The oxidation potential increase as the molar ratio increases, with noticeable changes between Examples 2 and 3 and between Examples 4 and 5. The increase in oxidation potential for the same material by increasing concentration of the lithium salt is unexpected.

TABLE 1
Properties of Examples 1-5 at 25° C.

| | Molar ratio | | Oxidation | Contact | Ionic |
|---|---|---|---|---|---|
| | (LiTFSI/ | | Potential | Resistance | Conductivity |
| Example | Sulfolane) | | (V) | (Ω) | (mS/cm) |
| Ex. 1 | 0.125 | (1:8) | 4.5 | 6.5 | 1.00 |
| Ex. 2 | 0.167 | (1:6) | 4.5 | 8.0 | 0.84 |
| Ex. 3 | 0.20 | (1:5) | 5.3 | 8.7 | 0.75 |
| Ex. 4 | 0.25 | (1:4) | 5.3 | 10.3 | 0.65 |
| Ex. 5 | 0.333 | (1:3) | 5.5 | 19.4 | 0.38 |

Contact resistance and ionic conductivity were measured based on the real part of the high-frequency (at 1 MHz) impedance (e.g., in Ωcm²) measured as part of generating the Nyquist plot, as described above. The contact resistance is the real part of the high-frequency impedance multiplied by the surface area of one of the stainless steel electrodes. The ionic conductivity is the inverse of the high-frequency impedance multiplied by the thickness of the interlayer (i.e., between the pair of stainless steel electrodes). As shown in Table 1, the contact resistance increases and the ionic conductivity decreases as the molar ratio increases, which is expected since a fraction of lithium ions in the interlayer associated with ionic conductivity decreases as the molar ratio increases.

The Li⁺ transference number was measured for Example 5 with the interlayer sandwiched between two lithium metal electrodes and was cycled from 3,000 seconds at 0.2 C between 2.8V and 4.5V at 25° C. before a current discharge was measured for 3,000 seconds. The initial current I₀ and resistance R₀ were measured at the beginning of the current discharge (t=0 seconds) while the steady-state current Iₛₛ and resistance Rₛₛ were taken from the long-time trend of the current discharge curve. Based on these measurements, the Li⁺ transference number t_{Li+} was calculated as t_{Li+}=Iₛₛ(10 mV−I₀R₀)/[I₀ (10 mV−IₛₛRₛₛ)]. For Example 5, the Li⁺ transference number t_{Li+} was 0.72

### Examples 6-9

Examples 6-9 comprise NCM523 cathode with a diameter of 12 mm, a lithium garnet (discussed below) solid-state electrolyte with a diameter of 13 mm and a thickness of 1 mm, and an anode comprising lithium metal melted on the solid-state electrolyte. NCM622 refers to LiNi_{0.6}Co_{0.2}Mn_{0.2}O₂ (precursor commercially available from Landt Instruments), which was formed into slurry with a 8:1:1 weight ratio of the precursor, super P carbon black (available from Timcal—Imerys), and poly(vinylidene fluoride) (PVDF) (dissolved in N-methylpyrrolidone) that was coated on aluminum (Al) foil with a predetermined thickness and dried under vacuum for 4 hours to achieve a loading of the NCM622 of 3 mg/cm² of an area of the first major surface of the cathode. The NCM622 cathode on the Al current collector was cut to form a disk with a diameter of 12 millimeters (mm). Examples 6-9 were processed in accordance with the methods discussed above with reference to FIGS. 5-6 to form a battery resembling the solid-state battery 201 shown in FIG. 2 in a CR2025 coin cell form with Ni foam disposed on the anode.

The lithium garnet solid-state electrolyte was cubic phase Li_{6.5}La₃Zr_{1.4}Ta_{0.5}O₁₂ (LLZTO), which was synthesized from a stoichiometric ratio of starting powders of LiOH·H₂O (AR), La₂O₃ (99.99%), ZrO₂ (AR), Ta₂O₅ (99.99%). 2 wt % excess of LiOH·H₂O added to compensate the lithium loss during processing. La₂O₃ was heated at 900° C. for 12 hours to remove any moisture and/or CO₂. The raw materials were mixed via a wet grinding process in which yttrium stabilized zirconium oxide (YSZ) balls and isopropanol (IPA) were used as the milling media. The mixture was dried and calcined at 900° C. for 12 hours in an alumina crucible to obtain pure cubic garnet phase powder. These powders were pressed into green pellets and sintered at 1250° C. for 1 hour, covered with LLZTO powder with 10 wt % Li excess in platinum crucibles to produce a disk with a thickness of 1 mm and a diameter of 13.5 mm.

Before assembly, the lithium garnet solid-state electrolyte sheets were dry polished. After that, in an argon-filled glovebox, fresh Li foils were melted onto one side of the lithium garnet solid-state electrolyte and was allowed to naturally cool to room temperature (i.e., 25° C.). The interlayer comprising the liquid electrolyte stated in Table 2 was disposed on the cathode with a ratio of a volume of the interlayer (20 μL) to an area of the first major surface of the cathode of 17.7 μL/cm², and then the exposed surface of the lithium garnet solid-state electrolyte (opposite the lithium anode) was placed on the liquid electrolyte wetted cathode. The Ni foam with the same diameter as Li anode was placed on the top of the anode, and the battery was sealed in a CR2025 coin cell with an applied pressure of 5 MPa.

As shown in Table 2, Examples 6-9 comprised a LiTFSI and sulfolane with the molar stated molar ratio. The interfacial resistance was measured at 25° C. from Nyquist plots for Examples 6-9, which were measured as described above. As discussed above with reference to FIG. 12, the as-formed interfacial resistance for Example 6 (curve 1205) is 42Ωcm², and after cycling Example 6 (curve 1207) comprises an interfacial resistance of 95 Ωcm². Both as-formed and after cycling, the interfacial resistance is less than 100 Ωcm². As shown in Table 2, Examples 6-9 comprise an as-formed interfacial resistance less than about 300 Ωcm² or less (e.g., about 250 Ωcm² or less, about 210 Ωcm² or less, about 100 Ωcm² or less, about 50 Ωcm², or less 100 Ωcm²). Going from Example 6 to Example 9, the interfacial resistance increases (as the molar ratio increases), which is consistent with the trend observed for Examples 1-5 in Table 1.

TABLE 2
Properties of Examples 6-9 at 25° C.

| | | | Interfacial | | Capacity | Capacity |
|---|---|---|---|---|---|---|
| | Molar ratio | | Resistance | Capacity | (250 cycles) | (350 cycles) |
| | (LiTFSI/ | | (as-formed) | (as-formed) | (mAh/g; %) | (mAh/g; %) |
| Example | Sulfolane) | | (Ω cm²) | (mAh/g) | (cutoff 4.6 V) | (cutoff 4.5 V) |
| Ex. 6 | 0.125 | (1:8) | 42 | — | — | — |
| Ex. 7 | 0.20 | (1:5) | 43 | 188 | 143; 73% | 166; 88% |
| Ex. 8 | 0.25 | (1:4) | 54 | — | — | — |
| Ex. 9 | 0.333 | (1:3) | 89 | 188 | 150; 77% | 175; 93% |

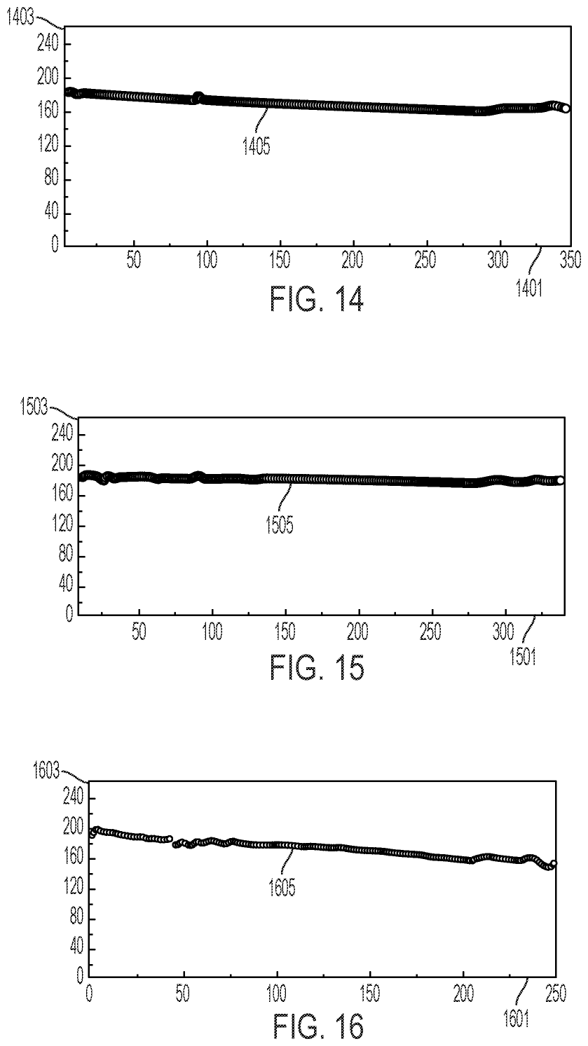

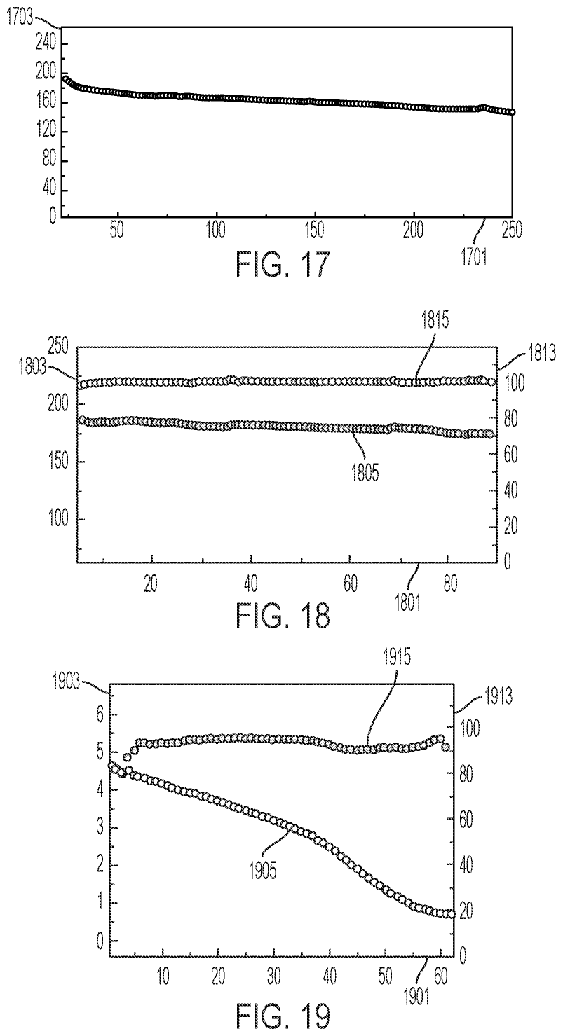

FIGS. 14 and 16 present cycling performance for Example 7. FIGS. 15 and 17 present cycling performance for Example 9. In FIGS. 14-17, the horizontal axis 1401, 1501, 1601, or 1701 corresponds to the cycle number, and the vertical axis 1403, 1503, 1603, or 1703 corresponds to the capacity in mAh/g, which was the capacity measured in the discharge portion of the cycle. Curves 1405 and 1505 in FIGS. 14-15 were used to determine the 250 cycle capacity and capacity retention presented in Table 2, where the 250 cycles occurred at 0.2 C with a cutoff voltage of 4.6V and at 25° C. Curves 1605 and 1705 in FIGS. 16-17 were used to determine the 350 cycle capacity and capacity retention presented in Table 2, where the 350 cycles occurred at 0.2 C with a cutoff voltage of 4.5V and at 25° C.

As discussed above, the as-formed capacity is measured for the second cycle. The cycling was conducted as discussed above at 25° C. and at 0.2 C with a cutoff voltage of 4.5V. As shown in Table 2, Examples 7 and 9 had the same as-formed capacity of 188 mAh/g. A single value is reported in Table 2 for the as-formed capacity even though slightly different as-formed capacity was measured for the batteries used for 250 cycles and 350 cycles, but the percent capacity retention is based on the as-formed capacity for that particular battery. Examples 7 and 9 have a capacity retention of 70% or more after 250 cycles at 25° C. and after 350 cycles at 25° C., which corresponds to a retained capacity of 140 mAh/g or more (after 250 cycles at 0.2 C with a cutoff voltage of 4.6V at 25° C.; and after 350 cycles at 0.2 C with a cutoff voltage of 4.5V and at 25° C.). Examples 7 and 9 have a capacity retention of 80% or more and 85% or more after 350 cycles at 25° C. Further, Example 9 has a capacity retention of 90% or more after 350 cycles at 25° C.

### Examples 10-11

Examples 10-11 comprise NCM523 cathode with a diameter of 12 mm, a lithium garnet solid-state electrolyte with a diameter of 13 mm and a thickness of 1 mm, the anode comprised lithium metal melted on the solid-state electrolyte. The cathode and the solid-state electrolyte were prepared as described above for Examples 6-9 except that the loading of the NCM 622 was 17.5 mg/cm² for Example 11 (and was cycled at 45° C. instead of 25° C.). Likewise, the anode was disposed on the solid-state electrolyte as described above for Examples 6-9. The interlayer of Example 11 was the same the interlayer for Example 5. For Example 10, the interlayer was formed by disposing a precursor solution comprising a molar ratio of LiTFSI to sulfolane of 0.333 (1:3), 8 wt % of a multifunctional (i.e., trifunctional) acrylate monomer (i.e., ethoxylated trimethylolpropane triacrylate), and 0.08 wt % of an initiator (i.e., AIBN) on the cathode. Then, the precursor solution was cured to form the interlayer by heating at 60° C. for 30 minutes. The solid-state electrolyte was disposed on the interlayer and the cathode so that the interlayer was positioned between the solid-state electrolyte and the cathode, as discussed above with reference to FIG. 6 or 9. The solid-state battery resembling the solid-state battery 201 or 401 shown in FIG. 2 or 4 was formed in a CR2025 coin cell form with Ni foam disposed on the anode and was sealed with an applied pressure of 5 MPa.

As discussed above with reference to FIG. 13, Example 13 comprised an as-formed interfacial resistance of 210 Ωcm² at 45° C. FIGS. 18-19 present cycling performance for Examples 10-11, respectively. In FIGS. 18-19, the horizontal axis 1801 or 1901 corresponds to the cycle number. In FIG. 18, the vertical axis 1803 on the left side corresponds to the capacity in mAh/g, which was the capacity measured in the discharge portion of the cycle. In FIG. 19, the vertical axis 1903 on the left side corresponds to the capacity in mAh/cm². In FIGS. 18-19, the vertical axis 1813 or 1913 on the right side corresponds to Columbic efficiency. Curves 1805 or 1905 represent capacity of Examples 10-11, respectively. Curves 1815 or 1915 represent Columbic efficiency of Examples 10-11, respectively. As shown in FIG. 18, curve 1815 demonstrates that Columbic efficiency of substantially 100% is maintained for all cycles tested at 45° C. In contrast, as shown in FIG. 19, curve 1915 shows lower Columbic efficiency of from about 90% to 95% for most of the cycles tested at 45° C.

Due to the higher cathode loading, the capacity is reported in Table 3 as mAh/cm² since the cathode loading is not limiting for Examples 10-11. As shown in Table 3, Examples 10 and 11 both comprise an as-formed capacity from about 3.3 mAh/cm² to about 3.8 mAh/cm². Example 10 comprises a capacity retention of 92% after 90 cycles at 45° C., which demonstrates that the interlayer comprising the polymeric matrix can provide high capacity retention even at elevated temperatures (e.g., 45° C.). Further, this demonstrates that the polymeric matrix does not substantially impact the initial capacity of the solid-state battery.

TABLE 3
Properties of Examples 10-11 at 45° C.

| | | Interfacial | | Capacity | Capacity | |
|---|---|---|---|---|---|---|
| | Liquid vs. | Resistance | Cathode | (as-formed) | (90 cycles) | Capacity |
| | Polymeric | (as-formed) | Loading | (mAh/g; | (mAh/g; | Retention |
| Example | Matrix | (Ω cm²) | (mg/cm²) | mAh/cm²) | mAh/cm²) | (90 cycles) |
| Ex. 10 | Polymeric Matrix | 210 | 17.5 | 187; 3.33 | 172; 3.06 | 92% |
| Ex. 11 | Liquid | — | 17.5 | 208; 3.72 | 39; 0.7 | 19% |

Example 11 comprises a capacity retention of only 19% after 90 cycles at 45° C. Compared to Example 9 (with the same interlayer composition as Example 11) at 25° C., the capacity retention is much worse in Example 11 at 45° C., which is the result of the lithium salt (LiTFSI) corroding the Al current collector at the elevated temperature. In contrast, Example 12 (comprising the polymeric matrix) at 45° C. has capacity retention after 90 cycles comparable to or slightly better than that of Example 9 at 25° C. This indicates that the polymeric matrix in the interlayer can reduce corrosion of the current collector while maintaining good capacity retention.

The above observations can be combined to provide solid-state batteries and methods of making the same comprising an interlayer comprising a lithium salt and a sulfone compound positioned between (e.g., at an interface) a cathode and a solid-state electrolyte. Providing the interlayer can decrease an interfacial resistance between the cathode and a solid-state electrolyte. In aspects, the interlayer can be a liquid electrolyte that can provide continuous and uniform ion paths at the interface and inside the cathode (e.g., wetting the cathode/SSE interface), for example, due to the high ionic conductivity of the liquid electrolyte and the ability of the liquid electrolyte to conform to the first major surface of the cathode and/or a surface of the solid-state electrolyte. For example, as demonstrated in the Examples discussed above, liquid electrolyte interlayers in accordance with the present disclosure can enable reduced interfacial resistance (e.g., about 100 Ωcm² or less or about 50 Ωcm² or less at 25° C. as-formed, after 250 cycles, and/or after 350 cycles) and/or increased capacity retention (e.g., about 70% or more at 25° C. after 250 cycles or 350 cycles). Compared to ionic liquid electrolytes, interlayers according to the present disclosure provide a lower-cost alternative that can be better suited for large-scale applications.

In aspects, the interlayer can comprise a crosslinked polymer matrix that can increase a viscosity of the interlayer and/or decrease a mobility of the lithium salt therein, which can reduce a rate of degradation of the cathode current collector. Providing a polymer matrix in the interlayer can reduce an amount of the lithium salt and/or sulfone compound that can travel away from the interface between the cathode and the solid-state electrolyte, which can increase a capacity retention of the solid-state battery and/or decrease an interfacial resistance after cycling. As demonstrated in the Examples, providing a polymer matrix (e.g., crosslinked polymer matrix) interlayer can reduce corrosion of the first current collector by the lithium salt in the interlayer, which can enable increased operating temperatures, increased longevity, and/or increased capacity retention of the solid-state battery. Providing the polymer matrix in accordance with the present disclosure can balance reducing the mobility of the lithium salt to reduce corrosion of the solid-state battery (e.g., current collector) with a potential decrease in ionic conductivity of the interlayer. As demonstrated in the Examples above, the polymeric matrix in the interlayer can reduce corrosion of the current collector while maintaining good capacity and capacity retention.

Providing and/or maintaining a low (e.g., about 300 Ωcm² or less, about 100 Ωcm² or less) interfacial resistance of the interlayer and/or the solid-state battery can enable the solid-state battery to have a longer life (e.g., withstand more cycles without failure), reduce losses and heating from increased interfacial resistance, and/or reduce the formation of dendrites (e.g., lithium dendrites) that can lead to failure of the solid-state battery. The interfacial resistance of interlayers and solid-state batteries containing the same in accordance with aspects of the disclosure can be reduced by more than one order of magnitude (e.g., 100× or more, 1000× or more) than a solid-state battery without an interlayer, which can have an interfacial resistance on the order of 100,000 Ωcm². Providing and/or maintaining a high capacity (e.g., 150 mAh/g or more as-formed or after 250 cycles or after 350 cycles at 25° C., 140 mAh/g or more as-formed or after 90 cycles at 45° C.,) can enable the solid-state battery to make efficient use of cathode materials (e.g., for an intended use for a longer period of time) than would otherwise be possible. Maintaining a high capacity retention (e.g., (e.g., 70% or more after 250 cycles at 25° C., 90% or more after 350 cycles at 25° C., 90% or more after 90 cycles at 45° C.) can enable the solid-state battery to be functional for an intended use for a longer period of time than would otherwise be possible.

Providing the ratio of the volume of the electrolyte interlayer to the area of the first major surface of the cathode can be sufficient to wet the interface between the cathode and the solid-state electrolyte while minimizing concerns associated with traditional liquid electrolytes (e.g., in liquid-based batteries or in hybrid liquid-solid batteries). As demonstrated in the Examples discussed above, providing a molar ratio in accordance with the present disclosure can provide a thermally stable and/or oxidatively stable interlayer that can increase a longevity of the solid-state battery and/or increase a capacity retention of the solid-state battery. Providing a thermally stable interlayer (e.g., to 100° C. or more, about 150° C. or more, about 175° C. or more) can increase a range of operating temperatures for the solid-state battery, increase a capacity retention of the solid-state battery, and/or increase a longevity of the solid-state battery.

Providing a cathode loading from about 1 mg/cm² to about 5 mg/cm² in combination with the interlayer described herein can make efficient use of cathode materials, for example, as demonstrated by the capacity in the Examples above. Providing the ratio of the volume of the interlayer to the area of the first major surface of the cathode can be sufficient to wet the interface between the cathode and the solid-state electrolyte while minimizing concerns associated with traditional liquid electrolytes (e.g., in liquid-based batteries or in hybrid liquid-solid batteries). Although not shown, the cathode can be disposed on the first current collector while the interlayer is disposed on the cathode.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A battery, comprising:
a current collector;
a cathode comprising a first major surface and a second major surface opposite the first major surface, the current collector disposed on the second major surface;
an interlayer disposed on the first major surface of the cathode, the interlayer comprising a polymeric matrix, a lithium salt, and a sulfone compound, the lithium salt and the sulfone compound positioned within the polymeric matrix;
a solid-state electrolyte disposed on the interlayer; and
a lithium anode disposed on the solid-state electrolyte.

2. The battery of claim 1, wherein the polymeric matrix comprises an acrylic-based polymer.

3. The battery of claim 1, wherein an interfacial resistance between the cathode and the solid-state electrolyte, as-formed, is about 300 Ωcm² or less at 25° C.

4. The battery of claim 1, wherein the battery comprises a capacity retention of about 90% or more after 90 cycles at 0.2 C with a cutoff voltage of 4.5V and at 45° C.

5. The battery of claim 1, wherein the battery comprises a capacity of about 150 mAh/g or more after 90 cycles at 0.2 C with a cutoff voltage of 4.5V and at 45° C.

6. The battery of claim 1, wherein the lithium salt comprises at least one of: lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof.

7. The battery of claim 1, wherein the sulfone compound comprises at least one of: sulfolane, 3-methylsulfolane, dimethyl sulfone, ethyl methyl sulfone, or combinations thereof.

8. The battery of claim 1, wherein the sulfone compound comprises sulfolane, and the lithium salt comprises lithium bis(trifluoromethanesulfonyl)imide (LiTFSI).

9. The battery of claim 1, wherein a molar ratio of the lithium salt to the sulfone compound is about 0.125 or more.

10. The battery of claim 9, wherein the molar ratio of the lithium salt to the sulfone compound is from about 0.2 to about 1.

11. The battery of claim 1, wherein the current collector comprises aluminum.

12. The battery of claim 1, wherein the cathode comprises at least one of lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0<d<1, 0<e<1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

13. The battery of claim 1, wherein a ratio of a weight of the cathode to an area of the first major surface is from about 1 mg/cm² to about 5 mg/cm².

14. The battery of claim 1, wherein a ratio of a volume of the interlayer to an area of the first major surface of the cathode from about 5 μL/cm² to about 20 μL/cm².

15. The battery of claim 1, wherein the solid-state electrolyte comprises lithium, lanthanum, zirconium, and oxygen.

16. The battery of claim 15, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N═In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I═In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or
a combination thereof.

17. A battery, comprising:
a current collector;
a cathode comprising a first major surface and a second major surface opposite the first major surface, the current collector disposed on the second major surface;
an interlayer disposed on the first major surface of the cathode, the interlayer comprising a lithium salt and a sulfone compound;
a solid-state electrolyte disposed on the interlayer; and
a lithium anode disposed on the solid-state electrolyte.

18. The battery of claim 17, wherein:
an interfacial resistance between the cathode and the solid-state electrolyte, as-formed, is about 100 Ωcm² or less at 25° C.;
the battery comprises a capacity retention of about 70% or more after 250 cycles at 0.2 C with a cutoff voltage of 4.5V and at 25° C.;
a capacity retention is about 90% or more after 350 cycles at 0.2 C with a cutoff voltage of 4.5V and at 25° C.;
the battery comprises a capacity of about 140 mAh/g or more after 90 cycles at 0.2 C with a cutoff voltage of 4.5V and at 25° C.; or
a combination thereof.

19. A method of forming a battery comprising:
disposing a precursor solution comprising a lithium salt, a sulfone compound, and a monomer on a first major surface of a cathode;
curing the monomer to form an interlayer comprising polymeric matrix with the lithium salt and the sulfone compound positioned within the polymeric matrix; and
disposing a solid-state electrolyte over the first major surface of the cathode, the interlayer positioned between the cathode and the solid-state electrolyte;
optionally wherein the precursor solution comprises from about 2 wt % to about 20 wt % of the monomer; and
optionally wherein the monomer is an acrylic monomer and the polymeric matrix comprises an acrylate-based polymer.

20. A method of forming a battery comprising:
disposing an interlayer comprising a lithium salt and a sulfone compound on a first major surface of a cathode; and
disposing a solid-state electrolyte over the first major surface of the cathode, the interlayer positioned between the cathode and the solid-state electrolyte;
optionally wherein a molar ratio of the lithium salt to the sulfone compound is about 0.125 or more;
optionally wherein the molar ratio of the lithium salt to the sulfone compound is from about 0.2 to about 1;
optionally wherein a ratio of a weight of the cathode to an area of the first major surface is from about 1 mg/cm² to about 5 mg/cm²; and
optionally wherein sulfone-based compound comprises sulfolane, and the lithium salt comprises lithium bis(trifluoromethanesulfonyl)imide (LiTFSI).
